(19) United States
(12) Patent Application Publication
(10) Pub. No.: US 2024/0086948 A1
(43) Pub. Date: Mar. 14, 2024

(54) PREDICTING FLEET UTILIZATION AND CAPACITY FOR DELIVERY DEMANDS

(71) Applicant: Rivian IP Holdings, LLC, Plymouth, MI (US)

(72) Inventors: Jennifer BRUCHHARDT, Campbell, CA (US); Daniel Andrew SUSSNA, Silverthorne, CO (US); Mohammed FARAG, Munich (DE); Jason SHIVERICK, San Francisco, CA (US); Jake BUCHER, San Jose, CA (US); Ketan DANDE, Union City, CA (US)

(21) Appl. No.: 18/109,196

(22) Filed: Feb. 13, 2023

Related U.S. Application Data
(60) Provisional application No. 63/404,941, filed on Sep. 8, 2022.

(51) Int. Cl. G06Q 30/0202; G06Q 10/083; G06Q 10/0834; G06Q 10/20

(52) U.S. Cl. CPC G06Q 30/0202; G06Q 10/0834; G06Q 10/0838; G06Q 10/20

(57) ABSTRACT

A method for predicting fleet utilization or capacity for fulfilling a delivery demand is provided. The method includes receiving vehicle data from vehicles in a fleet of vehicles associated with a location. The vehicle data is related to delivery information associated with the vehicles. The method includes determining, based on the vehicle data, a health status of the vehicles. The health status includes an indication of a health status of one or more components of the vehicles. The method includes generating a prediction of a fleet utilization or capacity for fulfilling a delivery demand based on the health status of the vehicles. The method includes transmitting, based on the prediction of the fleet utilization or capacity, information to transfer a delivery load from the vehicles to other vehicles in the fleet to fulfill the delivery demand.

### CROSS-REFERENCE TO RELATED APPLICATION

This application is a non-provisional application under 35 U.S.C. § 119(e) of U.S. Provisional Application No. 63/404,941, filed Sep. 8, 2022, the entire contents of which are hereby incorporated by reference in their entirety.

### INTRODUCTION

Vehicle components may involve inspection, maintenance, or replacement over time. When a component fails, such an event may cause problems with effects including minor inconvenience, loss of time, and repair costs due to vehicle malfunction. Even a minor vehicle malfunction or warning that resulting in unanticipated, temporary loss of use of a vehicle while it is being serviced can result in significant expense and/or downstream effects. In addition to the individual vehicle context, when managing a fleet of vehicles, it may be important to be able to monitor the status of individual vehicles, as well as to assess fleet-level information. For example, excessive tire wear and incorrectly inflated tires may lead to unevenly worn tires, loss of driving efficiency, and tire failure.

In another example, low-voltage batteries, such as a 12-volt lead-acid battery, may be used in an electric vehicle. For example, while the electric vehicle is in a sleep mode, the low-voltage battery may provide energy to parts (e.g., sensor, low-voltage electronics) of the electric vehicle. Unlike lead-acid batteries used in combustion engine vehicles (e.g., for the engine crank process), the lifetime and degradation of low-voltage batteries used in an electric vehicle may not be known and vary based on use cases. Due to the unknown lifetime and degradation, breakdown events associated with the low-voltage battery may not be known. Unexpected breakdown events may cause unplanned downtime for the electric vehicle. For example, the vehicle may not be functional until the low-voltage battery is repaired or replaced. In some instances, the electric vehicle is part of a fleet of electric vehicles (e.g., fleet of delivery vehicles), and unplanned downtime may cause disruption to the fleet schedule (e.g., causing delivery delays, causing re-planning).

In another example, the lifetime and degradation of a high-voltage battery (e.g., for providing energy to maneuver the electric vehicle) in an electric vehicle may not be known because the lifetime and degradation may vary based on use cases. For example, the lifetime and degradation may depend on energy consumption behavior, charging behavior, and environmental factors. Unexpected breakdown events, due to low battery state-of-health, may cause unplanned downtime for the electric vehicle. For example, the vehicle may not be functional until the high-voltage battery is repaired or replaced. Furthermore, due to low battery state-of-health, maximum vehicle state-of-charge may be less than expected, and the vehicle may need to be charged more than planned. In some instances, the electric vehicle is part of a fleet of electric vehicles (e.g., fleet of delivery vehicles), and unplanned downtime and/or delay may cause disruption to the fleet schedule (e.g., causing delivery delays, causing re-planning).

### SUMMARY

Embodiments of the present disclosure are directed to vehicle control systems, methods, and computer readable mediums for tracking vehicle health, predicting maintenance servicings (e.g., inspection, repair, replacement), determining maintenance recommendations, or providing alerts related to maintenance servicings or notifications related to recommendations.

Steps of embodiments described herein may be incorporated into fleet management software that predicts future maintenance servicings for a vehicle in the fleet based on real-time data derived from sensors on the vehicle, including displaying status information and providing alerts. The fleet management software may predict fleet utilization and capacity needs in a specified location based on historical downtime due to maintenance, real-time delivery load and routing demand, and the current health status of vehicles in the fleet. Such embodiments may or may not incorporate real-time data from vehicles (e.g., from on-board sensors). Embodiments described herein may provide fleet-level status information, including making predictions regarding fleet utilization and available capacity. Embodiments described herein may utilize one or more machine-learning models to make such predictions. Embodiments described herein may generate recommendations regarding optimal times to service vehicles in the fleet, based on fleet utilization needs (e.g., volume of deliveries—both current and predicted, delivery routes, or third-party maintenance provider availability). Embodiments described herein may predict a need to order new vehicles and/or vehicle components based on predicted fleet utilization and available capacity.

The systems and methods of the present disclosure may estimate mechanical wear associated with vehicle components based on sensor signals from sensors built into specific locations on the vehicle and can proactively generate recommendations for servicing the vehicle components, thereby reducing vehicle downtime and maintenance costs.

In some embodiments, the method includes receiving, by a control module of the vehicle, signals generated by a number of sensors built into specific locations on the vehicle. In some embodiments, the method includes identifying, by the control module of the vehicle, one or more indicators of a condition of a component of the vehicle based on features of the generated signals. In some embodiments, the method includes transmitting, by a telecommunications module of the vehicle to a vehicle data analysis system, information associated with the one or more indicators. In some embodiments, the method includes receiving, by the telecommunications module of the vehicle from the vehicle data analysis system, a recommendation for servicing the vehicle. In some embodiments, the recommendation is based on a prediction related to the one or more indicators and is identified by the vehicle data analysis system using a machine-learning (ML) model trained to predict component failures using historical vehicle service data. In some embodiments, the method includes displaying, by a user interface module of the vehicle, a notification regarding the recommendation for servicing the vehicle.

In some embodiments, identifying the one or more indicators includes determining, by the control module of the vehicle, a measurement of damage associated with the vehicle component. In some embodiments, the method includes tracking, by the control module of the vehicle, the measurement of damage associated with the component over time to generate a trend of damage associated with the component, identifying, by the control module of the vehicle, a change in a rate of mechanical wear associated with the component based on the trend, and transmitting, by the telecommunications module to the vehicle data analysis system, the information based on identifying the change in the rate of mechanical wear. In some embodiments, displaying the notification includes displaying an indication related to a status of the component.

In some embodiments, specific signals may be received from each of the vehicles in the fleet and corresponding predictions regarding the need to perform maintenance, repair, or replacement on a specific vehicle for components such as, by way of example and not limitation, tires and batteries. Embodiments described herein may predict a need to inflate one or more tires based on current tire pressure, historical patterns of tire pressure, tire temperature, ambient conditions, other vehicle signals and vehicle usage data. Embodiments described herein may predict a need to replace one or more tires or rotate two or more tires by computing tire tread depth (based on rolling radius) using on-board signals such as GPS-based vehicle speed, wheel speed, tire pressure, steering angle, as well as other types of information specific to the tire, such as tire type, size, brand, or rating. Embodiments described herein may predict a need to replace a high-voltage electric vehicle (EV) battery based on a prediction of battery end-of-life for vehicle use based on state-of-health-related parameters. Embodiments described herein may predict need to inspect or replace a low-voltage (e.g., 12-volt) battery based on a number of cycles of charging/discharging, average operating temperature during cycles of charging and discharging, and a depth of discharge during a cycle of charging and discharging.

Another implementation of the present disclosure is an on-board vehicle control system for performing steps of embodiments described herein.

Another implementation of the present disclosure is a non-transitory computer-readable medium including instructions for performing steps of embodiments described herein.

Another implementation of the present disclosure is a computing system for performing steps of embodiments described herein. In some embodiments, the computing system includes one or more servers including one or more non-transitory computer-readable storage media having instructions stored thereon. In some embodiments, the computing system includes one or more processors coupled to the one or more storage media.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example embodiment of a fleet management system and fleet operating system (OS).

FIGS. 2A and 2B illustrate an example embodiment of a fleet management system and fleet OS workflow for tire health and wear management for a pickup truck.

FIGS. 2C and 2D illustrate an example embodiment of a fleet management system and fleet OS workflow for tire health and wear management for a delivery van.

FIG. 2E illustrates an example workflow diagram for servicing a low-voltage battery.

FIG. 2F illustrates an example flowchart for servicing a low-voltage battery.

FIG. 2G illustrates an example flowchart for charging a high-voltage battery.

FIGS. 3A-3O illustrate one or more example screenshots of a user interface (UI) or portions thereof for fleet management software.

FIG. 4A is a flowchart illustrating a method of computing wear for a vehicle and ranking a number of vehicles based on wear.

FIG. 4B illustrates a method of computing component wear for a vehicle.

FIG. 5 is a flowchart illustrating a method of monitoring wear for a vehicle.

FIG. 6 illustrates an example of monitoring component wear for a vehicle and identifying a component in need of service.

FIG. 7 is a flowchart illustrating a method of determining a maintenance schedule for a vehicle.

FIG. 8 is a flowchart illustrating a method of generating a recommendation for servicing a vehicle.

FIG. 9 is a flowchart illustrating a method of monitoring component wear for a vehicle.

FIG. 10A illustrates an example of generating a recommendation for servicing a vehicle and scheduling a service appointment based on the recommendation.

FIG. 10B illustrates an example of providing additional data associated with the operation of a vehicle to a service provider.

FIG. 11 is a flowchart illustrating a method of performing vehicle analysis.

FIG. 12 illustrates an example network system including a connected vehicle.

FIG. 13A is a schematic of an example computer system.

FIG. 13B illustrates example firmware for a vehicle ECU.

### DESCRIPTION OF EXAMPLE EMBODIMENTS

Embodiments of the present disclosure are directed to vehicle control systems, methods, and computer readable mediums for tracking vehicle health, predicting maintenance servicings (e.g., inspection, repair, replacement), determining maintenance recommendations, or providing alerts related to maintenance servicings or notifications related to recommendations.

Steps of embodiments described herein may be incorporated into fleet management software that directed to fleet management software that predicts future maintenance servicings for a vehicle in the fleet based on real-time data derived from sensors on the vehicle, including displaying status information and providing alerts. The fleet management software may predict fleet utilization and capacity needs in a specified location based on historical downtime due to maintenance, real-time delivery load and routing demand, and the current health status of vehicles in the fleet. Such embodiments may or may not incorporate real-time data from vehicles (e.g., from on-board sensors). Embodiments described herein may provide fleet-level status information, including making predictions regarding fleet utilization and available capacity. Embodiments described herein may utilize machine-learning artificial intelligence to make such predictions. Embodiments described herein may generate recommendations regarding optimal times to service vehicles in the fleet, based on fleet utilization needs (e.g., volume of deliveries—both current and predicted, delivery routes, or third-party maintenance provider availability). Embodiments described herein may predict a need to order new vehicles and/or vehicle components based on predicted fleet utilization and available capacity.

The systems and methods of the present disclosure may estimate mechanical wear associated with vehicle components based on sensor signals from sensors built into specific locations on the vehicle and can proactively generate recommendations for servicing the vehicle components, thereby reducing vehicle downtime and maintenance costs.

In some embodiments, the method includes receiving, by a control module of the vehicle, signals generated by a number of sensors built into specific locations on the vehicle. In some embodiments, the method includes identifying, by the control module of the vehicle, one or more indicators of a condition of a component of the vehicle based on features of the generated signals. In some embodiments, the method includes transmitting, by a telecommunications module of the vehicle to a vehicle data analysis system, information associated with the one or more indicators. In some embodiments, the method includes receiving, by the telecommunications module of the vehicle from the vehicle data analysis system, a recommendation for servicing the vehicle. In some embodiments, the recommendation is based on a prediction related to the one or more indicators and is identified by the vehicle data analysis system using a machine learning (ML) model trained to predict component failures using historical vehicle service data. In some embodiments, the method includes displaying, by a user interface module of the vehicle, a notification regarding the recommendation for servicing the vehicle.

In some embodiments, identifying the one or more indicators includes determining, by the control module of the vehicle, a measurement of damage associated with the vehicle component. In some embodiments, the method includes tracking, by the control module of the vehicle, the measurement of damage associated with the component over time to generate a trend of damage associated with the component, identifying, by the control module of the vehicle, a change in a rate of mechanical wear associated with the component based on the trend, and transmitting, by the telecommunications module to the vehicle data analysis system, the information based on identifying the change in the rate of mechanical wear. In some embodiments, displaying the notification includes displaying an indication related to a status of the component.

In some embodiments, specific signals may be received from each of the vehicles in the fleet and corresponding predictions regarding the need to perform maintenance, repair, or replacement on a specific vehicle for components such as, by way of example and not limitation, tires and batteries. Embodiments described herein may predict a need to inflate one or more tires based on current tire pressure, historical patterns of tire pressure, tire temperature, ambient conditions, other vehicle signals and vehicle usage data. Embodiments described herein may predict a need to replace one or more tires or rotate two or more tires by computing tire tread depth (based on rolling radius) using on-board signals such as GPS-based vehicle speed, wheel speed, tire pressure, steering angle, as well as other types of information specific to the tire, such as tire type, size, brand, or rating. Embodiments described herein may predict a need to replace a high-voltage electric vehicle (EV) battery based on a prediction of battery end-of-life for vehicle use based on state-of-health-related parameters. Embodiments described herein may predict need to inspect or replace a low-voltage (e.g., 12-volt) battery based on a number of cycles of charging/discharging, average operating temperature during cycles of charging and discharging, and a depth of discharge during a cycle of charging and discharging.

Embodiments of the present disclosure are directed towards vehicle control systems, methods, and computer readable mediums for tracking vehicle health and determining a maintenance schedule for a vehicle. Specifically, systems and methods of the present disclosure enable a data-driven vehicle maintenance schedule based on what is uniquely known about each individual vehicle through on-board signal monitoring and analysis. Vehicles may be fitted with various sensors, which may include a number of high-bandwidth tri-axial accelerometers to facilitate monitoring for mechanical wear. The information from the accelerometers may be integrated with other signals generated by the vehicle inside a module on board the vehicle to allow for real-time, synchronous processing to provide an indication of the vehicle's need for service. The signals may be processed using a combination of artificial intelligence (AI) and physics-based algorithms that compute various health metrics for specific vehicle subsystems. These computed metrics may subsequently be stored in a cloud-based vehicle ledger. Trend analysis may also be performed on the health metrics, which may help to reveal any potential areas of concern, and potentially to generate appropriate response actions. Trend analysis may include determining a rate of wear accumulation. For example, the platform may generate a recommendation to service a component based on identifying an increase in a rate of wear associated with the component (or another associated component).

Wear mechanisms create unique noise and vibration signatures. Measuring these signals alongside other vehicle signals, interpreting them, and then trending them may provide an indication of that individual vehicle's need for service and may be useful for other applications. One example may be in an end-of-line audit as an in-vehicle application where it may be used for quality audit tests on vehicles exiting assembly. Particular embodiments may serve as the interface to record error states and promote usage of data over subjective evaluation. An embodiment may provide the ability to measure data on any vehicle without the need for extensive instrumentation. That data may then be uploaded to the cloud containing automated data processing to search for error states. Alternatively, the platform may aid service technicians in diagnosis of customer concerns, allowing a data-driven approach to diagnosis, which may in turn mitigate turnaround times at service centers. Further, various embodiments may run behind the scenes while a vehicle is being driven by a customer, making routine evaluations and sending health information back to the cloud.

The platform may collect a number of signals from sensors embedded in a vehicle that may be useful in diagnosing the status of different vehicle components. In some embodiments, an on-board module receives the signals. Additionally or alternatively, a cloud-based data processing system (e.g., a vehicle data analysis system, etc.) may receive the signals. For example, the on-board module may receive a first set of signals and perform a first type of analysis (e.g., physics-based analysis, etc.) on the first set of signals and a cloud-based data processing system may receive a second set of signals and perform a second type of analysis (e.g., AI-based analysis, etc.) on the second set of signals. The signals may be associated with a health of the vehicle/vehicle components (e.g., vibration data, microphone data, data describing torque applied to a component of the vehicle, etc.), a user's operation of the vehicle (e.g., steering angle data, throttle/brake pedal apply data, wheel speed data, drive unit speed/torque data, etc.), and/or an environmental context of the vehicle (e.g., ambient temperature data, data describing a following distance of the vehicle, data describing characteristics of a road surface the vehicle is traveling on, etc.).

In certain embodiments, the on-board module and/or the cloud-based data processing system analyze the signals (or a subset thereof) to generate subsequent information (e.g., health metrics, error states, recommendations, etc.). For example, the on-board module may analyze vibration data and/or microphone data to generate one or more health metrics associated with the vehicle and/or vehicle components. In certain embodiments, the health metrics include a measurement of wear such as vibration-based wear and/or strain-based wear. For example, the on-board module may apply a transfer function to vibration data to determine strain at a component and may compute an accrued rainflow matrix using the strain at the component to generate a measurement of strain-based wear for the component. In certain embodiments, the on-board module and/or the cloud-based data processing system update a database with the one or more health metrics.

For example, the on-board module may compute strain-based wear associated with a component of a vehicle accumulated over a 24-hour period and may update a database entry associated with the vehicle to include the accumulated strain-based wear. The database may store various metrics associated with a vehicle, a fleet of vehicles, and/or the like. For example, the database may include a ledger listing a number of components associated with a vehicle and a measurement of wear associated with each of the components. In certain embodiments, the cloud-based data processing system and/or the on-board module compute derived metrics using the various metrics stored in the database. For example, the cloud-based data processing system may generate an average measurement of wear associated with a vehicle based on computing an average of a number of component-specific wear metrics corresponding to the vehicle. As another example, the cloud-based data processing system may perform a regression analysis using a number of health metrics corresponding to a fleet of vehicles to identify a common failure mode of the fleet of vehicles (e.g., a spline threading that consistently goes out of alignment, etc.). As another example, the on-board module may compare a measurement of wear associated with each component of a vehicle to a threshold corresponding to each component to identify components in need of service. In some embodiments, the database stores raw sensor data from one or more vehicles.

In some embodiments, the on-board module and/or cloud-based data processing system analyze vibration data and/or microphone data to diagnose one or more concerns associated with a vehicle and/or vehicle component. In certain embodiments, the concerns may include brake squeal, excess wind noise (e.g., mirror whistle, etc.), excess road noise, HVAC health, an AC compressor fault, an out-of-balance rotor, drive bushing deterioration, chassis bushing deterioration, brake rotor thickness variation, excessive brake pad wear, wheel/tire imbalance, chassis damper leaks/failures, chassis misalignment, tire wear, gear/bearing failures (e.g., a wheel bearing failure, etc.), a half-shaft fracture, a CV joint fracture, and/or the like. For example, the on-board module may compute a Fast-Fourier Transform (FFT) of vibration data with respect to a rotational speed of a drive unit of a vehicle and may diagnose an AC compressor fault based on identifying a frequency signature in the FFT associated with an AC compressor fault. In some embodiments, the platform maintains a database including a number of frequency signatures corresponding to various concerns/error states.

In some embodiments, the on-board module may transmit sensor data and/or information derived therefrom to an external system such as a service provider computing system and/or an insurance provider computing system. For example, the on-board module may receive a request from a service provider computing system for data to facilitate diagnosing a concern with the vehicle corresponding to an upcoming service appointment and in response the on-board module may transmit vibration data (e.g., tri-axial accelerometer data, etc.) to the service provider computing system.

In certain embodiments, the platform (e.g., the cloud-based data processing system and/or the on-board module, etc.) proactively generates recommendations based on correlating stored health metrics with other data. For example, the platform may correlate a user's driving pattern with trends in component wear to generate suggestions for the user on how to adjust their driving to reduce further wear on the vehicle. As another example, the platform may correlate trends in component wear with location data to identify portions of road associated with accelerated wear on the vehicle (e.g., due to potholes, a rough road surface, an excess of speed bumps, etc.) and may generate routing recommendations to avoid such portions (e.g., by using a different road, using a different lane, etc.). As another example, the platform may analyze vehicle health metrics to proactively generate recommendations for servicing the vehicle before a component failure occurs (e.g., a brake pad wears out, a component cracks, a brake line requires bleeding, etc.) and may automatically schedule a service appointment based on the recommendation. In some embodiments, the platform may integrate with external systems such as a service system to automatically schedule service and/or facilitate resource allocation by transmitting information associated with the type of recommended service (e.g., wheel alignment, brake caliper replacement, etc.) and/or any parts associated with the recommended service. The service provider may use this information to prepare for the service appointment (e.g., to order parts, schedule technicians with the required skills, etc.), thereby reducing service delays and increasing service throughput.

In certain embodiments, the platform enables data-driven design and development of new vehicles/components. For example, the platform may analyze vehicle usage data and/or historic health metrics to determine how customers use their vehicles (e.g., how many off-road miles, how many highway miles, etc.) rather than designers assuming this information. Additionally, the platform may analyze previous designs using historic health metrics to identify improvements for future designs. For example, the platform may analyze historic health metrics to determine that a vehicle component cracks in a specific location and designers may design a new component with increased strength in the specific location.

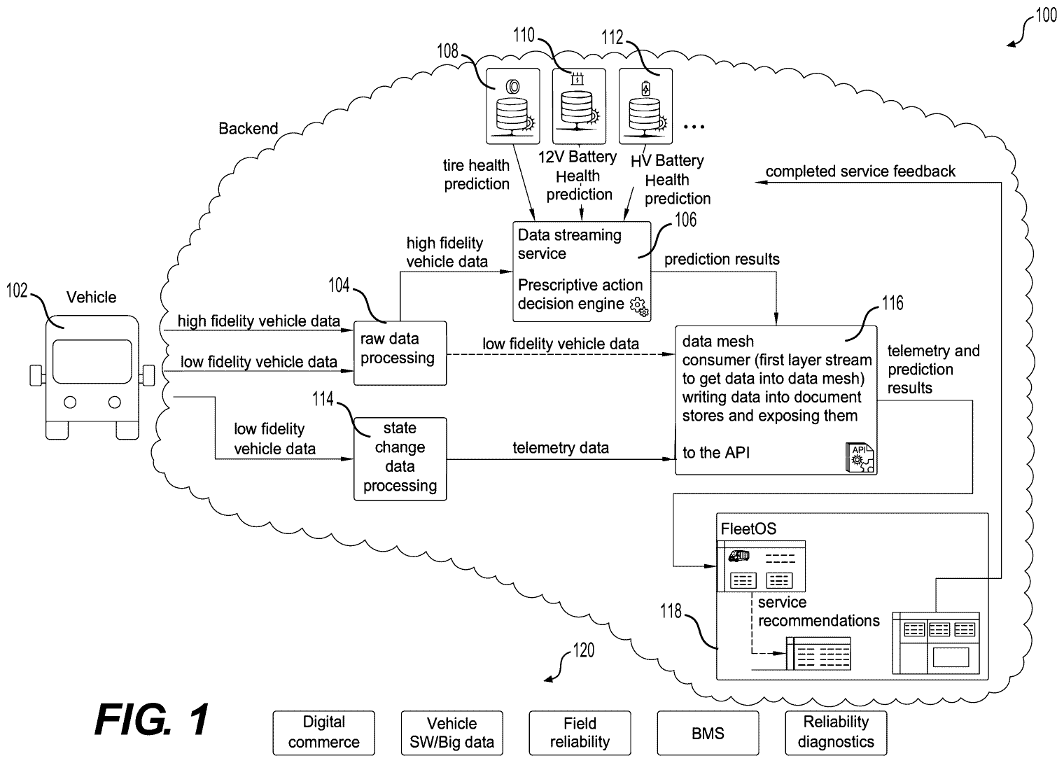

FIG. 1 illustrates an example embodiment of a fleet management system and fleet operating system (OS) environment 100, in accordance with the presently disclosed embodiments. In certain embodiments, the fleet management system and fleet may collectively include any software system, hardware system, or some combination thereof that may utilize vehicle telematics data to track, analyze, and manage, for example, vehicle fleet operations, vehicle location, service delivery and coverage, driver behavior, community safety, vehicle drive paths and routing, vehicle diagnostics and preventative maintenance, and so forth across a large fleet (e.g., thousands or millions) of vehicles. For example, the fleet management system and fleet OS may oversee all fleet performance and fleet maintenance in order to increase reliability and service efficiency.

For example, in one embodiment, the fleet management system and fleet OS environment 100 may include a Platform as a Service (PaaS) architecture, a Software as a Service (SaaS) architecture, a Compute as a Service (CaaS) architecture, a Data as a Service (DaaS) architecture, a Database as a Service (DBaaS) architecture, or other similar cloud-based computing architecture (e.g., “X” as a Service (XaaS)). In certain embodiments, the fleet OS may allow one or more fleet managers to view and manage all fleet operations, including vehicle maintenance, fuel consumption and fuel costs, driver management, asset utilization, route planning, and the implementation of one or more services that may improve service and safety.

While the present embodiments may be discussed herein primarily with respect an electric motor passenger vehicle 102, it should be appreciated that the present embodiments may applied to any type of vehicle or fleet of vehicles (e.g., aircrafts, watercrafts, railcars, semi-trailer trucks, farming vehicles, rover vehicles, scooters, buses, and so forth) that may employ one or more electric motors. As depicted, the vehicle 102 may include any passenger vehicle (e.g., a car, a truck, a pickup truck, a sports utility vehicle (SUV), a minivan, a crossover utility vehicle (CUV), a cargo van, a towing truck) that may be utilized for transportation and to navigate one or more rural environments, urban environments, and/or off-roading and mountainous environments.

In one embodiment, the vehicle 102 may include a gasoline-powered vehicle that may be propelled, for example, by an internal combustion engine (ICE) or other fuel-injection engine. In certain embodiments, the vehicle 102 may include, for example, an electric vehicle (EV), a battery electric vehicle (BEV), a hybrid electric vehicle (HEV), a plug-in hybrid electric vehicle (PHEV), or other vehicle 102 that may be in part or wholly propelled by one or more electric motors (e.g., synchronous electric motors, permanent magnet synchronous electric motors (PMSMs), induction motors (IMs), line start synchronous motors (LSSMs), line start permanent magnet motors (LSPMMs), synchronous reluctance motors (SynRMs)) utilizing power stored to one or more batteries included in the vehicle 102.

As illustrated by FIG. 1, the fleet management system and OS environment 100 may continuously or intermittingly receive over one or more networks low fidelity vehicle data and high fidelity vehicle data from one or more vehicles 102 of the fleet of vehicles. In certain embodiments, the low fidelity vehicle data and high fidelity vehicle data may be provided to a data preprocessing system 104 for preprocessing raw vehicle data. The high fidelity vehicle data may be then passed to a data streaming service engine 106. In certain embodiments, the data streaming service engine 106 may also receive, for example, generated prediction data including tire health prediction data 108, battery health prediction data 110, and high-voltage prediction data 112.

In certain embodiments, the low fidelity vehicle data may also be passed to a state change processing engine 114 to generate processed telemetry data. In certain embodiments, the prediction data including tire health prediction data 108, battery health prediction data 110, and high-voltage prediction data 112 may be generated utilizing, for example, one or more machine-learning models executing on one or more artificial intelligence (AI) accelerators (e.g., one or more processors suitable for hosting and executing various machine-learning models). The processed telemetry data, the prediction data, and the low fidelity vehicle data may be then provided to a data mesh consumer 116.

In certain embodiments, the data mesh consumer 116 may then provide the processed telemetry data and prediction data may to be displayed via the fleet OS 118. In certain embodiments, the fleet OS 118 may include a number of application tabs 120 for toggling between various vehicle fleet data. For example, in some embodiments, a fleet manager may utilize the fleet OS 118 and the number of application tabs 120 to view the processed telemetry data and prediction data and determine whether a service corresponding to the tire health prediction data 108, battery health prediction data 110, and high-voltage prediction data 112 has been scheduled or performed. Based on whether the tire health prediction data 108, battery health prediction data 110, and high-voltage prediction data 112, a feedback signal may be provided to evaluate the accuracy of one or more of the tire health prediction data 108, battery health prediction data 110, and high-voltage prediction data 112.

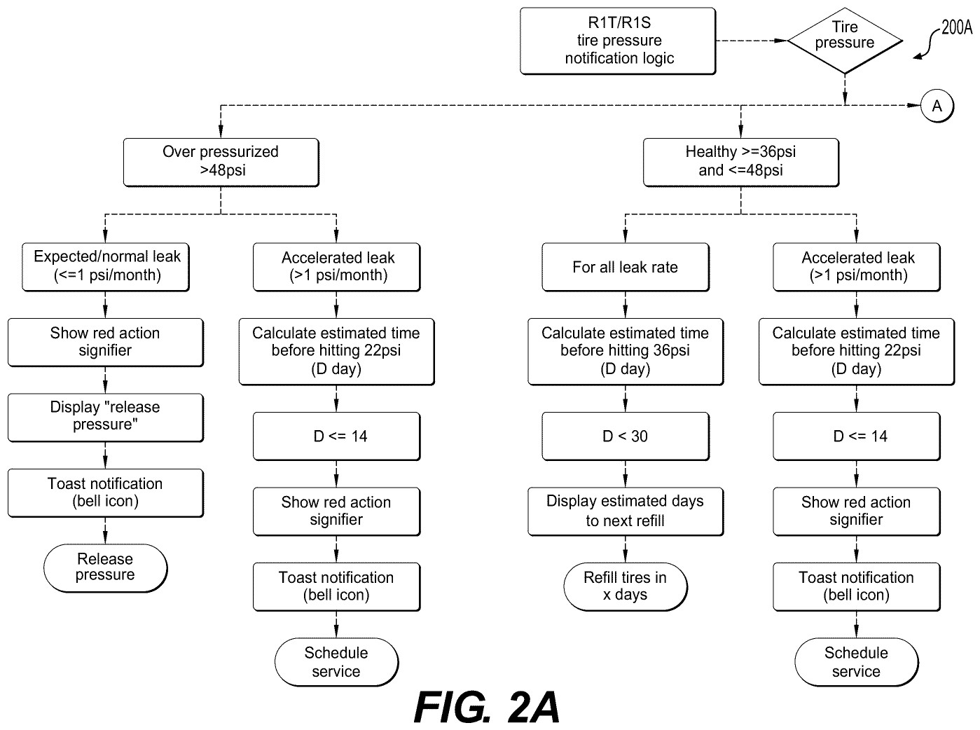

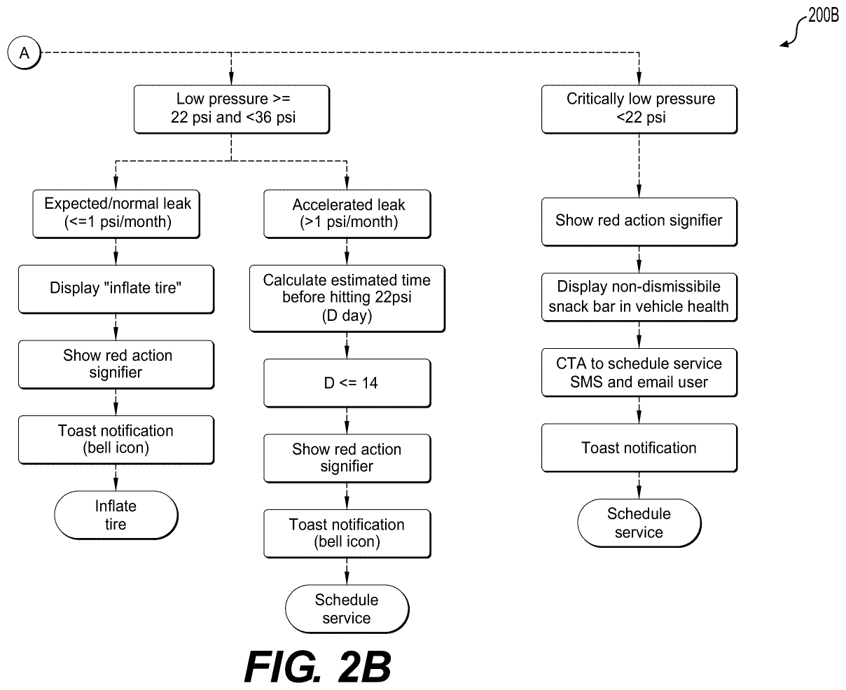

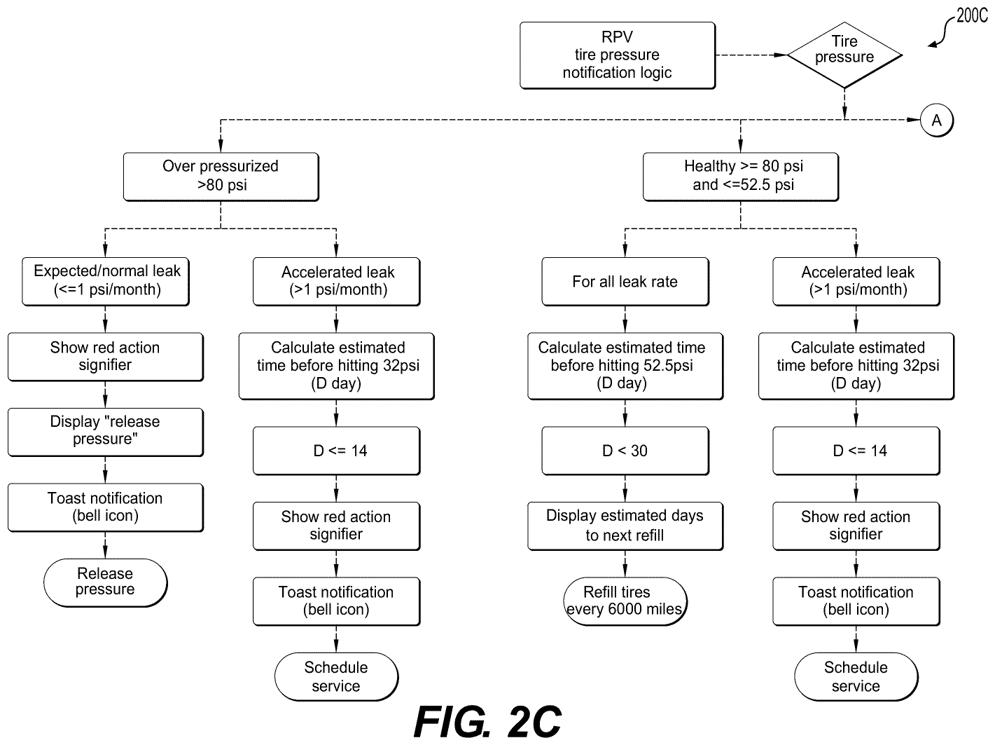

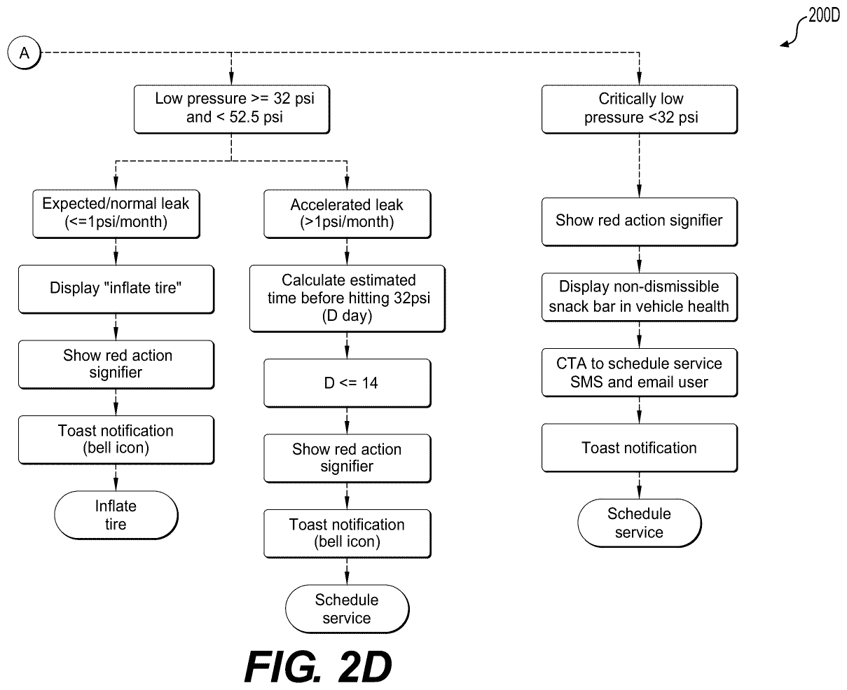

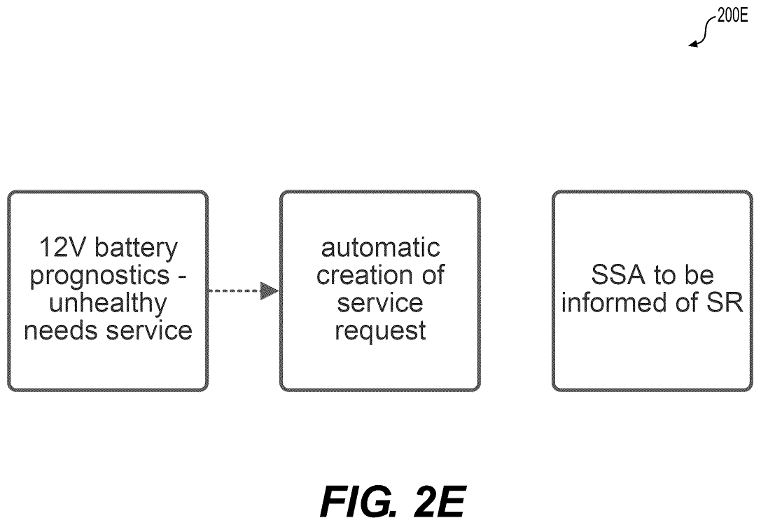

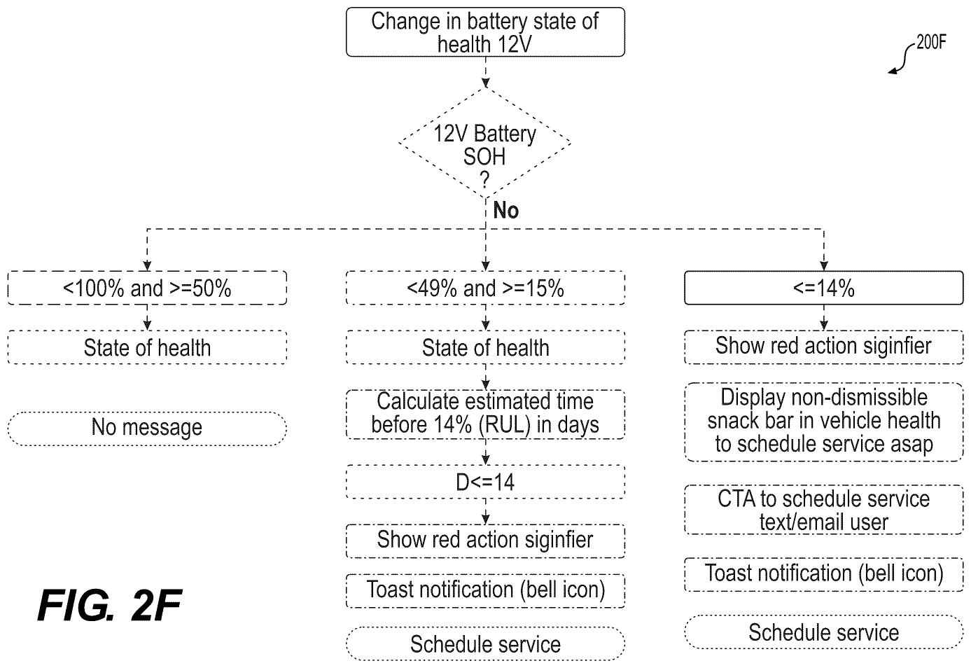

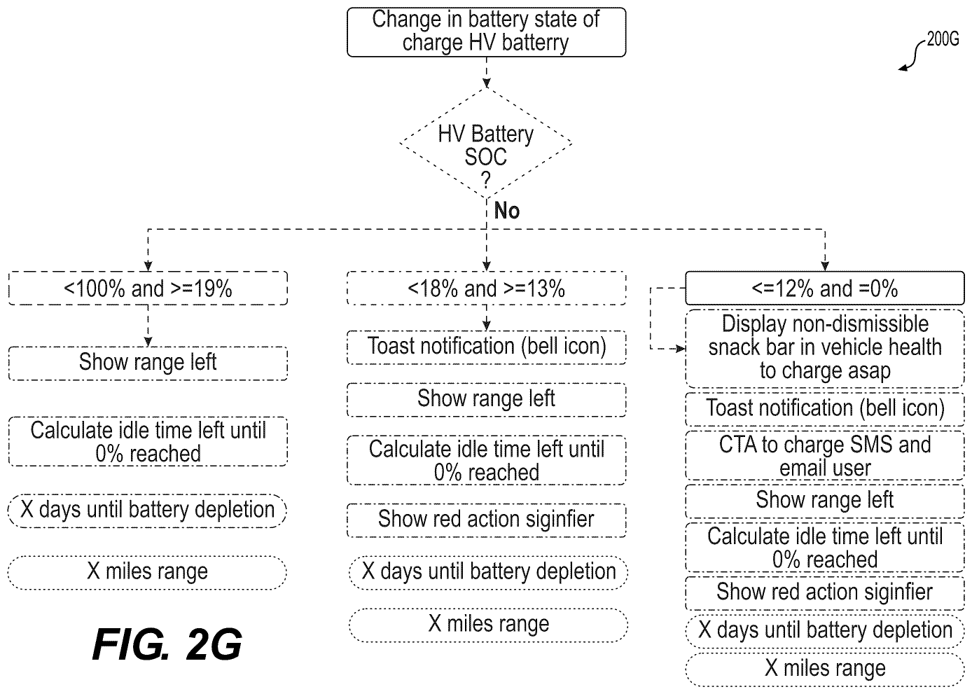

FIGS. 2A and 2B illustrate an example embodiment of a fleet management system and fleet OS workflow 200A, 200B for tire health and wear management for a vehicle, in accordance with the presently disclosed embodiments. As illustrated, tire pressure notification logic may provide one or more tire pressure parameters (e.g., for each tire of the vehicle 102 of the fleet of vehicles 102) for evaluation. In certain embodiments, above 48 pounds per square inch (psi) may be logged as over-pressurized, a range of 48 psi to 36 psi may be logged as optimally-pressurized, a range of 35 psi to 22 psi may be logged as low-pressurized, and below 22 psi may be logged as critically-low-pressurized and requiring immediate or near-immediate service.

In certain embodiments, for the over-pressurized logic flow, the fleet management system and fleet OS 100 may calculate or predict tire air pressure leak for vehicle normal operating conditions, vehicle accelerated operating conditions, and a time before remaining before reaching 22 psi or below based on the historical vehicle operating conditions, present vehicle conditions, or future or near-future vehicle operating conditions. The fleet management system and fleet OS 100 may recommend that tire air pressure be decreased. In certain embodiments, for the optimally-pressurized logic flow, the fleet management system and fleet OS 100 may calculate or predict tire air pressure leak for vehicle normal operating conditions, vehicle accelerated operating conditions, and a time before remaining before reaching 36 psi and 22 psi or below, respectively, based on the historical vehicle operating conditions, present vehicle conditions, or future or near-future vehicle operating conditions. The fleet management system and fleet OS 100 may recommend that tire air pressure increased in the next “X” days, for example.

In certain embodiments, for the low-pressurized logic flow, the fleet management system and fleet OS 100 may calculate or predict air pressure leak for vehicle normal operating conditions, vehicle accelerated operating conditions, and a time before remaining before reaching 22 psi or below, based on the historical vehicle operating conditions, present vehicle conditions, or future or near-future vehicle operating conditions. The fleet management system and fleet OS 100 may recommend that tire air pressure be increased. In certain embodiments, for the critically-low-pressurized logic flow, the fleet management system and fleet OS 100 may immediately or near-immediately recommend that service be performed on one or more tires of the vehicle 102.

FIGS. 2C and 2D illustrate an example embodiment of a fleet management system and fleet OS 100 workflow 200C, 200D for tire health and wear management for a delivery van, in accordance with the presently disclosed embodiments. As illustrated, tire pressure notification logic may provide one or more tire pressure parameters (e.g., for each tire of the vehicle 102 of the fleet of vehicles 102) for evaluation. In certain embodiments, above 80 psi may be logged as over-pressurized, a range of 80 psi to 52.5 psi may be logged as optimally-pressurized, a range of 52.5 psi to 32 psi may be logged as low-pressurized, and below 32 psi may be logged as critically-low-pressurized and requiring immediate or near-immediate service.

In certain embodiments, for the over-pressurized logic flow, the fleet management system and fleet OS 100 may calculate or predict tire air pressure leak for vehicle normal operating conditions, vehicle accelerated operating conditions, and a time before remaining before reaching 32 psi or below based on the historical vehicle operating conditions, present vehicle conditions, or future or near-future vehicle operating conditions. The fleet management system and fleet OS 100 may recommend that tire air pressure be decreased. In certain embodiments, for the optimally-pressurized logic flow, the fleet management system and fleet OS 100 may calculate or predict tire air pressure leak for vehicle normal operating conditions, vehicle accelerated operating conditions, and a time before remaining before reaching 52.5 psi and 32 psi or below, respectively, based on the historical vehicle operating conditions, present vehicle conditions, or future or near-future vehicle operating conditions. The fleet management system and fleet OS 100 may recommend that tire air pressure increased in the next “X” days, for example.

In certain embodiments, for the low-pressurized logic flow, the fleet management system and fleet OS 100 may calculate or predict air pressure leak for vehicle normal operating conditions, vehicle accelerated operating conditions, and a time before remaining before reaching 32 psi or below, based on the historical vehicle operating conditions, present vehicle conditions, or future or near-future vehicle operating conditions. The fleet management system and fleet OS 100 may recommend that tire air pressure be increased. In certain embodiments, for the critically-low-pressurized logic flow, the fleet management system and fleet OS 100 may immediately or near-immediately recommend that service be performed on one or more tires of the vehicle 102.

FIG. 2E illustrates an example workflow diagram 200E for servicing a low-voltage battery (e.g., a 12V battery, a lead-acid battery). In some embodiments, as illustrated, it is determined that the low-voltage battery requires service. For example, it is determined that the state-of-health of the low-voltage battery is below a threshold health level (e.g., when difference between the number of cycles and expected lifetime cycles is below a threshold value, when ratio between the number of cycles and expected lifetime cycles is above a threshold value, when damage accumulation is above a threshold percentage). In accordance with a determination that the state-of-health of the low-voltage battery is below a threshold health level, a server request is created. In some embodiments, the service request is created by an electronic device (e.g., an electric vehicle, a server, a mobile device). In some embodiments, the service request is created in response to receiving an input (e.g., from a user after receiving a notification indicating low battery state-of-health). The input may comprise a form completed by the user.

In some embodiments, in response to creation of the service request, the service request is transmitted. For example, the service request is transmitted to an electronic device associated a service support advisor (SSA). The electronic device associated with the SSA and/or the SSA may determine a repair plan based on the service request. In some embodiments, the SSA is a manager of a fleet of electric vehicles, and the fleet comprises the electric vehicle requesting the service. In some embodiments, information associated with the low-voltage battery (e.g., data from BMS module, cycle information, Depth of Discharge information, temperature data) are transmitted to the electronic device associated with the SSA.

In some embodiments, a first electronic device of a first advisor (e.g., the SSA, a fleet manager) receives the service request (and other information). The first electronic device associated with the advisor may display information associated with the service request (e.g., hi-fi data from the vehicle, lo-fi data from the vehicle, the form, additional information, information about the vehicle and/or user) for review.

In some embodiments, a determination of whether a sufficient amount of information is received is made. For example, a sufficient amount of information may be a necessary amount of information for first advisor, the first electronic device associated with the first advisor, and/or a server to determine a plan for addressing an issue associated with the vehicle event (e.g., low battery state-of-health). The first electronic device associated with the first advisor may receive the information associated with the service request and determine whether a sufficient amount of information is received. The first advisor may alternatively or additionally review the received information and, based on the review, determine whether a sufficient amount of information is received.

In some embodiments, in accordance with a determination that a sufficient amount of information is not received, the user of the vehicle is contacted for additional information. The first electronic device associated with the first advisor may communicate with the vehicle or an electronic device associated with user for requesting the additional information. For example, the first advisor may communicate with the user via a phone call, text messaging, or email for requesting the additional information. As another example, the user interface of vehicle or a user interface of the user's electronic device is updated to request the additional information.

In some embodiments, the service request may be created by the first electronic device associated with the first advisor based on the information received (e.g., information associated with low battery state-of-health), and/or input from first advisor (after reviewing the information from the vehicle and/or the user). In some embodiments, the service request may be transmitted by the first electronic device associated with first advisor to a second electronic device associated with a second advisor (e.g., a repair plan advisor).

In some embodiments, the service request and data associated with the vehicle (e.g., hi-fi and/or lo-fi data transmitted from the vehicle) are evaluated. The service request and data may be received by the second electronic device associated with the second advisor, and the service request and data may be presented by the second electronic device for the second advisor's review. The service request and log data may be evaluated by the second electronic device or a server.

In some embodiments, a repair plan is created. For example, based on the service request and log data, the second electronic device determines an underlying reason for causing the vehicle event (e.g., for causing the low battery state-of-health) and a repair plan for addressing an issue associated with the vehicle event. Alternatively or additionally, the service request and data are transmitted to a server (e.g., to a server from the vehicle, an electronic device of the user, the first electronic device associated with the first advisor, the second electronic device associated with the second advisor, or any combination thereof), and the server determines an underlying reason for causing the vehicle event and at least a part of the repair plan and transmits the part of the repair plan to the second electronic device. The repair plan may be determined based on an operational state of one or more electrical control units onboard the vehicle. For example, the battery is determined to be malfunctioning based on the received data, and the repair plan comprises instructions for repairing the malfunctioning component. The repair plan may also comprise information regarding the operational state of the one or more electrical control units associated with the vehicle event.

In some embodiments, the repair plan is communicated. For example, the first advisor contacts the user to discuss the repair plan over a phone call, text messaging, and/or email. As another example, the repair plan is transmitted to the vehicle and/or an electronic device of user.

In some embodiments, a determination of whether to proceed with the repair plan is made. For example, after reviewing the repair plan, the user provides an input indicating whether to proceed with the repair. The input may be provided to the user interface of the vehicle or the electronic device associated with the user. The input may be provided during the discussion with the first advisor.

In some embodiments, in accordance with a determination to proceed with the repair plan or a part of the repair plan, an instruction to proceed is transmitted, for example, to the first electronic device associated with the first advisor. The instruction indicates the determination to proceed with the repair plan or the part of the repair plan (e.g., a part of the repair plan associated with a more critical or time-sensitive repair). In accordance with this determination, an appointment for addressing an issue associated with the vehicle event is scheduled and resources for addressing the issue are determined and requested (e.g., ordering a new battery, ordering parts for the repair, dispatching roadside assistance, scheduling mechanics, reserving equipment).

In some embodiments, the appointment is scheduled based on a schedule of the vehicle (e.g., delivery schedule). For example, the appointment is scheduled at a time when the vehicle is not scheduled for delivery. The appointment may be communicated and saved to the vehicle, an electronic device associated with the user, the first electronic device associated with the first advisor, or any combination thereof. The resources for addressing the issue may be determined and requested by the first electronic device associated with the first advisor, the second electronic device associated with the second advisor, a server 220, or any combination thereof.

In some embodiments, the repair is performed in accordance with the repair plan. For example, a mobile mechanic is dispatched at a scheduled time to address the low battery state-of-health issue. As another example, a mechanic addresses the low battery state-of-health issue when the vehicle is not scheduled for delivery.

In some embodiments, in accordance with a determination to not proceed with the repair plan, an instruction indicating that the repair plan is declined is transmitted, for example, to the first electronic device associated with the first advisor. For example, the user is able to address the low battery state-of-health issue without assistance of a mechanic. The repair plan may be saved, and the appointment and resources for addressing the issue may be determined and requested at a later time (e.g., when the user requests the repair in the future, when the battery state-of-health further degrades).

The low-voltage battery may provide energy to parts (e.g., sensor, low-voltage electronics) of the electric vehicle while the electric vehicle is in a sleep mode. The lifetime of low-voltage batteries used in an electric vehicle may not be known and vary based on use cases. Due to the unknown lifetime, breakdown events associated with the low-voltage battery may not be known. By creating a service request in accordance with a determination of low battery state-of-health, breakdown events may be prevented and/or more quickly addressed, reducing unplanned downtime for the electric vehicle (e.g., and allowing fleet schedule to be more closely followed).

In some embodiments, the electric vehicle is operated based on its battery state-of-health. For example, if the low-voltage battery state-of-health is determined to be low (e.g., by an electronic device of a fleet manager, by the electric vehicle, by a server), a user of the delivery vehicle may not be allowed to longer or more breaks, to reduce the Depth of Discharge and degradation of the low-voltage battery. As another example, if the low-voltage battery state-of-health is determined to be low (e.g., by the electric vehicle, by a server), the vehicle charges the low-voltage battery at a slower rate in accordance with this determination, to reduce degradation of the battery. As another example, if the low-voltage battery state-of-health is determined to be low (e.g., by an electronic device of a fleet manager, by the electric vehicle, by a server), the schedule of the vehicle is updated to accommodate battery repair and/or maintenance (e.g., return to depot earlier than initially scheduled for repair, stop for repair).

In some embodiments, battery prognostics (e.g., for the low-voltage battery) is performed to monitor the health of the battery and to predict its remaining useful life (RUL). In some embodiments, health management is performed by utilizing prognostic information for making decisions related to safety, condition-based maintenance, ensuring adequate inventory, and product life extension. Performing battery prognostics and health management may reduce unnecessary and unplanned maintenance and help with scheduling proactive maintenance. In some embodiments, the model for battery prognostics and health management are advantageously customizing and scalable (e.g., flexible enough to adapt to different batteries in different vehicles), computationally efficient, and configured for short-term and long-term prediction.

In some embodiments, performing battery prognostics and health management comprises utilizing data science, statistics, and physics. For example, system or battery degradation is understood, and damage evolution is identified. Based on information such as scientific paper, research, and previous data (e.g., historical data of a fleet, historical data from vehicle manufacturers, test data), a damage evolution model in time is developed. In some embodiments, the model of damage evolution in time has an associated model error to show potential error in this time dependent model.

In some embodiments, damage and degradation to the battery are measured by direct and/or indirection measurements. In some embodiments, these measurements have an associated error to show potential error in measurements. In some embodiments, the model damage evolution in time (with model error) and the damage measurements (with measurement error) are integrated and used to update the battery prognostics model in real time. The prognostic model may be used to predict damage in the future.

In some embodiments, the effective cycle counts may be provided to a table associated with cumulative cycles per battery per car. This information may be provided to a damage prognostics model (e.g., for a low-voltage battery). In some embodiments, the prognostic method comprises particle filtering method, which comprises performing stochastic recursive Bayesian Estimation (e.g., advantageously for non-linear systems and non-Gaussian noise). The damage prognostics model may comprise a state process model, which shows the evolution of damage through time and can be determined from e.g., underlying physics, empirical data, test data, field data, or any combination thereof, and a measurement model, which shows the relationship between the state process's estimation and actual data observed via sensors. Based on the model, damage estimation may be determined (e.g., in vehicle state-of-health). Based on the estimation, RUL prediction may be performed, and the RUL predictions may be provided to a table.

In some embodiments, the low-voltage battery is a lead-acid battery. Damage modeling prognostics for the lead-acid battery (e.g., based on number of effective cycles adjusted by temperature and Depth of Discharge) may be based on linear damage accumulation in early life of the battery (in some embodiments, this is advantageously adjusted for a fleet of vehicles) (e.g., associated with short-term prediction) and exponential growth of damage accumulation close to end of life (e.g., as a function of days in service) (e.g., associated with long-term prediction). The prognostics model advantageously allow prediction of battery healthy while requiring less impractical laboratory-level information/data to further train the model. In some examples, for a short-term prediction, a measured damage follows the damage estimated performed via the particle filter method closely.

In some embodiments, the prognostic method performed via particle filtering method tracks the evolution of damage using a plurality of random particles or samples (e.g., hundreds). Each sample may be one possible representation of damage estimation at a timestamp. When the prediction phase (prognostics) starts (e.g., the time input to the model is a future time), because there may be no measurement to correct the particle location, the particles began to disperse more farther into the future and providing a distribution of possible future damage estimates (e.g., represented by time of failure). In some embodiments, the future is predicted until cumulative damage reaches a predefined failure threshold (e.g., 100%), and there is an associated distribution of when this may happen (e.g., in service days). Having a time-to-failure distribution advantageously allow extraction of different percentiles that can be used for future decision making. RUL may be calculated based on the current age (e.g., in cumulative damage) of the battery and the time-to-failure distribution.

Although FIG. 2E is described with respect to a low-voltage battery, it should be appreciated that a service request may be created for another component of the vehicle, such as a high-voltage battery.

FIG. 2F illustrates an example flowchart 200F for servicing a low-voltage battery. In some embodiments, the flowchart illustrates a process for determining whether service for the low-voltage battery should be scheduled. Steps described with respect to FIG. 2F may be performed by an electric vehicle and/or an electronic device separate from the electric vehicle (e.g., a server, an electronic device associated with a fleet manager for managing the electric vehicle).

For example, as illustrated, the state-of-health of the low-voltage battery is determined, as described herein. In some embodiments, if the battery state-of-health is determined to be less than 100% and greater than or equal to 50%, then transmission of an instruction (for further action) is forgone (e.g., by the electric vehicle, by an electronic device separate from the electric vehicle) because, for example, the battery is determined to be sufficiently healthy. It should be appreciated that the illustrated thresholds state-of-health values for determining an action to be performed are exemplary. It should also be appreciated that the process described with respect to FIG. 2F may be performed for a high-voltage battery.

In some embodiments, if the battery state-of-health is determined to be less than 50% and greater than or equal to 15%, then a time until 14% battery state-of-health is determined. In some embodiments, if the estimated time is less than or equal 14 days, then an instruction to present an indication of low battery health is transmitted. For example, an instruction to present an indication of low battery health is transmitted to the electric vehicle and/or an electronic device of a fleet manager, and in response, the electric vehicle and/or the electronic device of the fleet manager present, via a user interface, a red action signifier and/or toast notification (e.g., a bell icon, a notification that may be dismissed). In response to this instruction, service for the battery can be scheduled automatically or in response to user input in response to the low battery health alert (e.g., as described above). In some embodiments, if the estimated time is not less than or equal 14 days, then transmission of an instruction (for further action) is forgone (e.g., by the electric vehicle, by an electronic device separate from the electric vehicle) because, for example, the battery is determined to be sufficiently healthy.

In some embodiments, if the battery state-of-health is determined to be less than 15%, then an instruction to present an indication of low battery health is transmitted. For example, an instruction to present an indication of low battery health is transmitted to the electric vehicle and/or the electronic device of the fleet manager, and in response, the electric vehicle and/or the electronic device of the fleet manager present, via a user interface, a red action signifier, a non-dismissible notification (e.g., a snack bar), a toast notification (e.g., a bell icon), or any combination thereof. The notifications may prompt a user and/or the vehicle to schedule service as soon as possible to address the battery's low state-of-health. In response to this instruction, service for the battery can be scheduled automatically or in response to user input in response to the low battery health alert (e.g., as described above).

FIG. 2G illustrates an example flowchart 200G for charging a high-voltage battery. In some embodiments, the flowchart illustrates a process for determining whether the high-voltage battery should be charged. Steps described with respect to FIG. 2G may be performed by an electric vehicle and/or an electronic device separate from the electric vehicle (e.g., a server, an electronic device associated with a fleet manager for managing the electric vehicle).

For example, as illustrated, the state-of-charge of the high-voltage battery is determined (e.g., by the BMS ECU). In some embodiments, if the battery state-of-charge is determined to be less than 100% and greater than or equal to 19%, then a range (e.g., in miles) of the battery is displayed (e.g., on an interface of the vehicle, on an interface presented to a fleet manager). Additionally, an idle time (e.g., time spent in sleep mode) until 0% state-of-charge is reached is calculated, and this idle time may be displayed (e.g., on an interface of the vehicle, on an interface presented to a fleet manager). It should be appreciated that the illustrated thresholds state-of-charge values for determining an action to be performed are exemplary.

In some embodiments, if the battery state-of-charge is determined to be less than 19% and greater than or equal to 13%, then an instruction to present an indication of low battery state-of-charge is transmitted. For example, an instruction to present an indication of low battery state-of-charge is transmitted to the electric vehicle and/or an electronic device of a fleet manager, and in response, the electric vehicle and/or the electronic device of the fleet manager present, via a user interface, a red action signifier and/or toast notification (e.g., a bell icon) indicating low battery state-of-charge. Additionally, a range (e.g., in miles) of the battery is displayed (e.g., on an interface of the vehicle, on an interface presented to a fleet manager), and an idle time (e.g., time spent in sleep mode) until 0% state-of-charge is reached is calculated. This idle time may be displayed (e.g., on an interface of the vehicle, on an interface presented to a fleet manager).

In some embodiments, if the battery state-of-charge is determined to be less than 13%, then an instruction to present an indication of low battery state-of-charge is transmitted. For example, an instruction to present an indication of low battery state-of-charge is transmitted to the electric vehicle and/or the electronic device of the fleet manager, and in response, the electric vehicle and/or the electronic device of the fleet manager present, via a user interface, a red action signifier, a non-dismissible notification (e.g., a snack bar), a toast notification (e.g., a bell icon), or any combination thereof, indicating the low battery state-of-charge. The notifications may prompt a user and/or the vehicle to charge the vehicle as soon as possible to address the battery's low state-of-charge. The notifications may also prompt a fleet manager to notify a user vehicle and/or the vehicle to charge the vehicle as soon as possible to address the battery's low state-of-charge. Additionally, a range (e.g., in miles) of the battery is displayed (e.g., on an interface of the vehicle, on an interface presented to a fleet manager), and an idle time (e.g., time spent in sleep mode) until 0% state-of-charge is reached is calculated. This idle time may be displayed (e.g., on an interface of the vehicle, on an interface presented to a fleet manager).

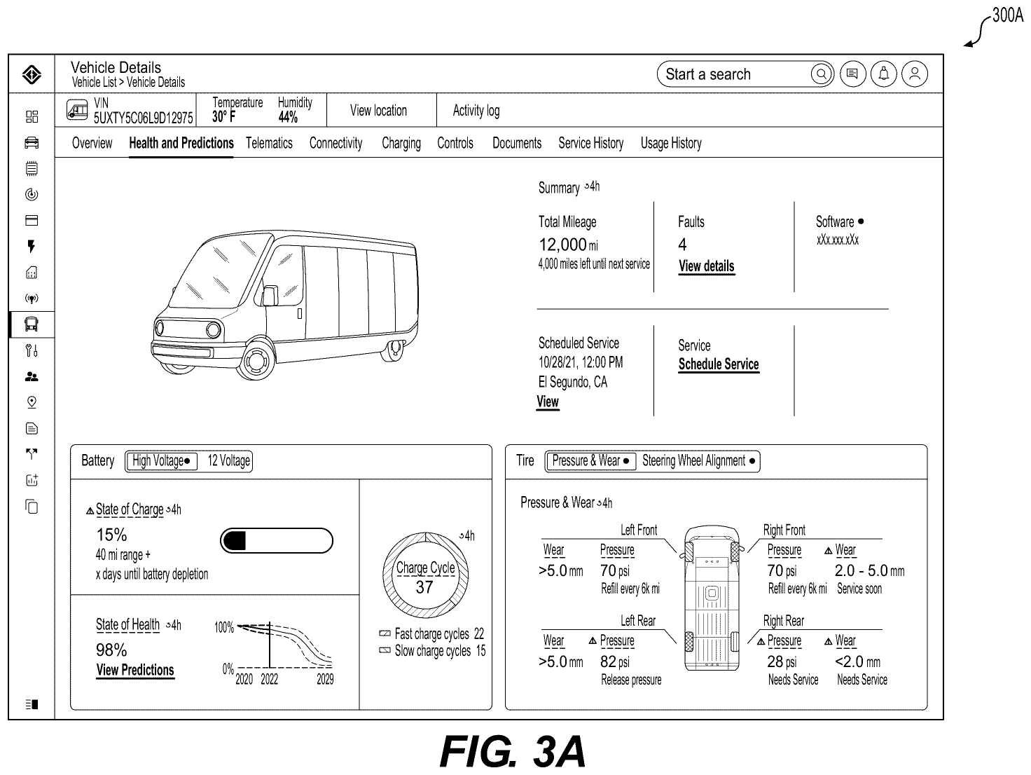

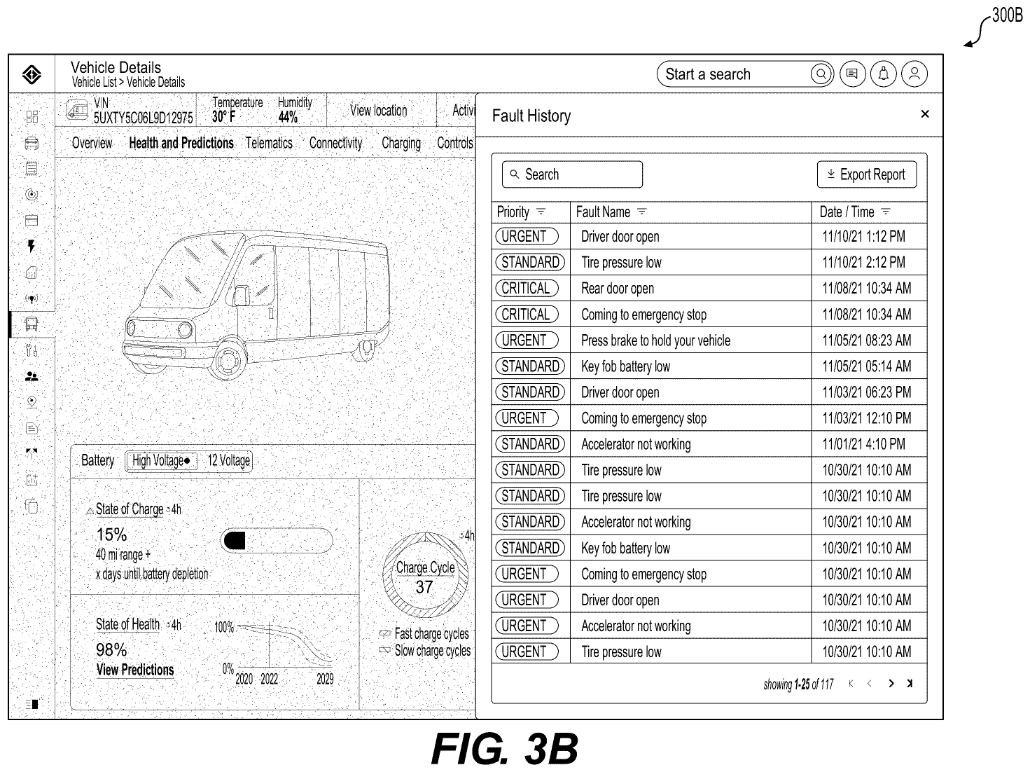

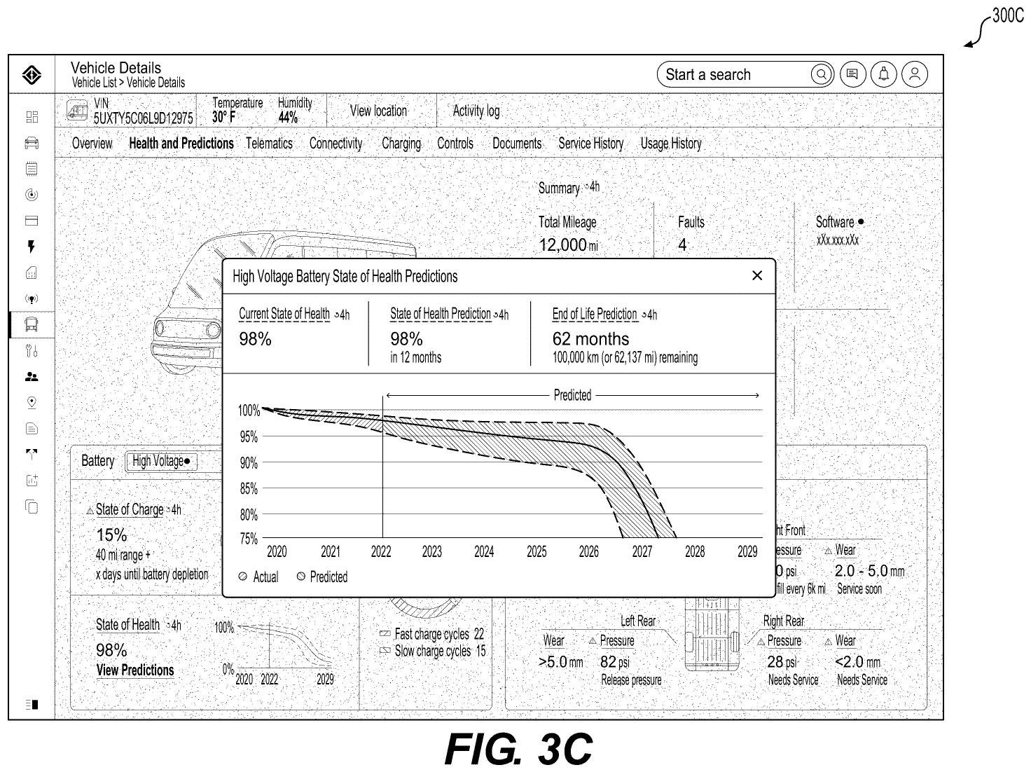

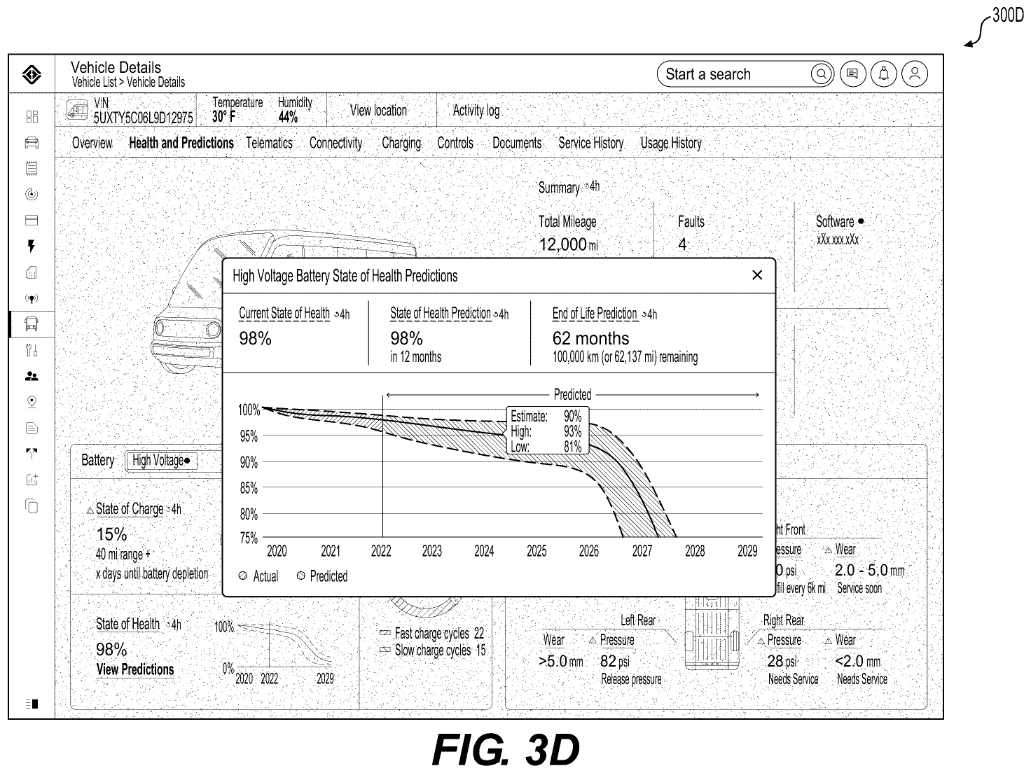

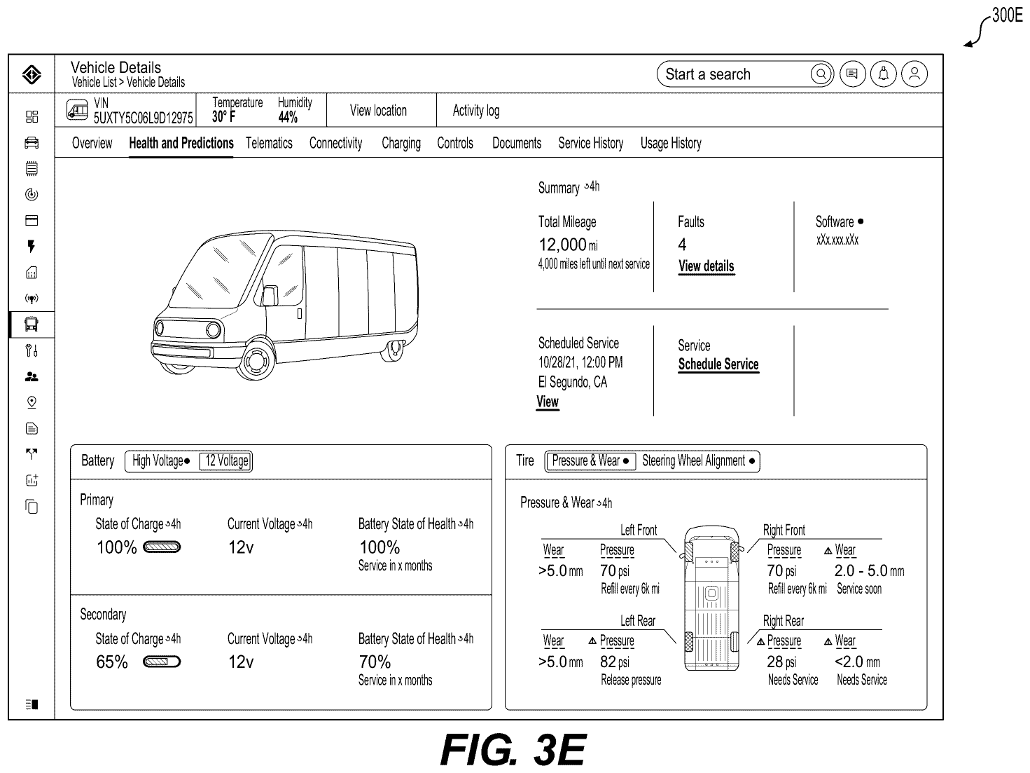

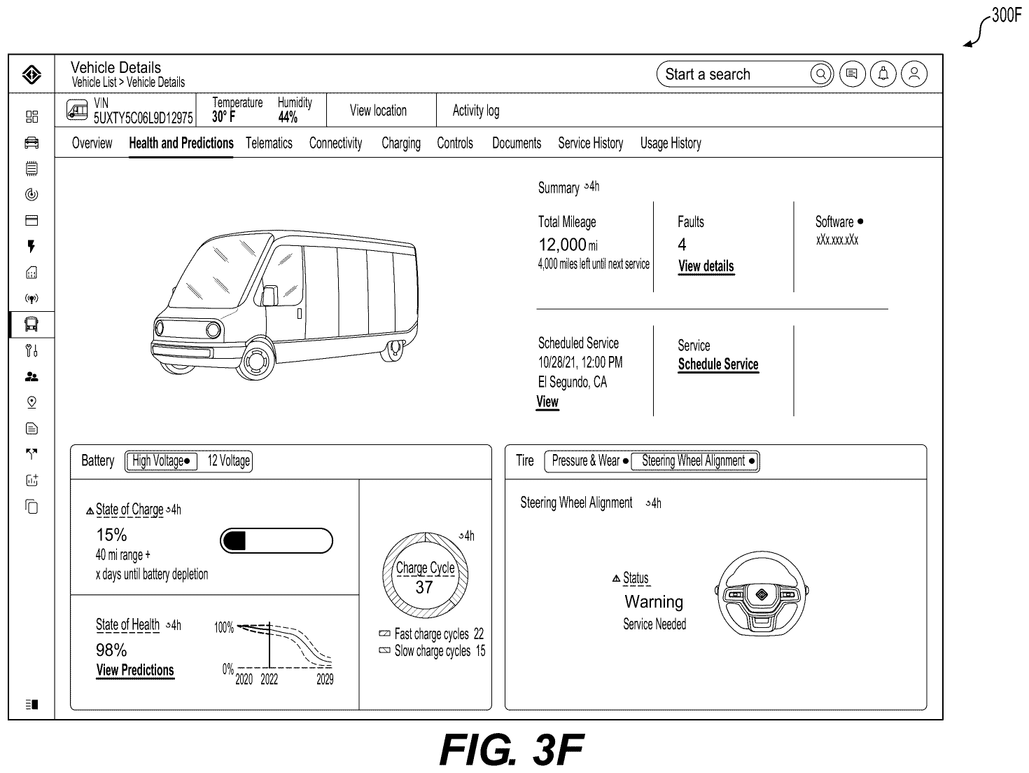

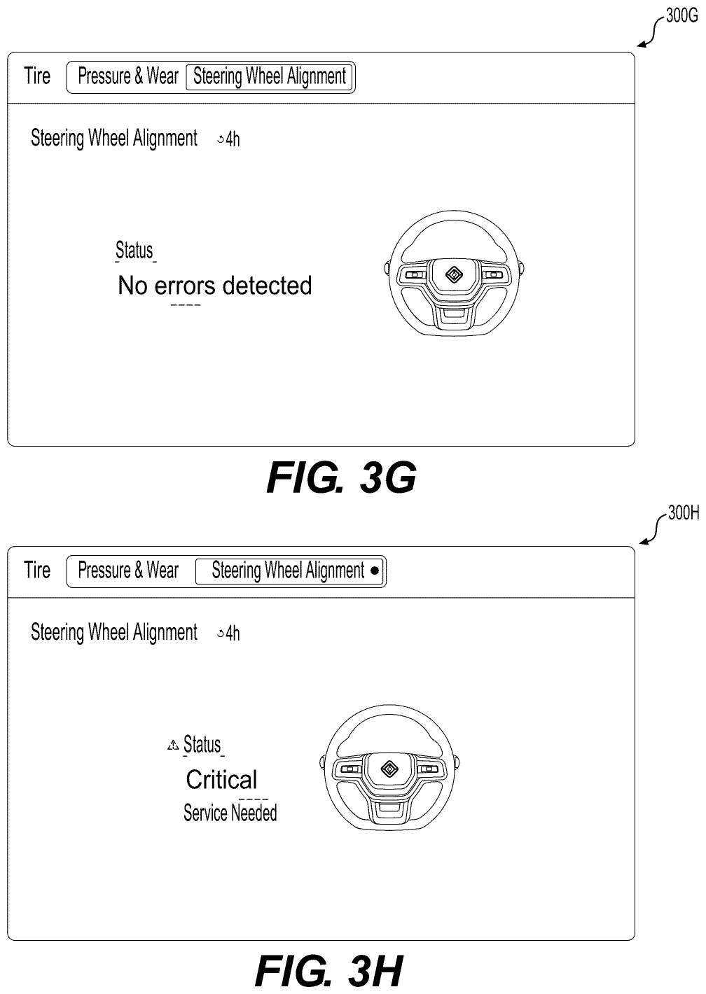

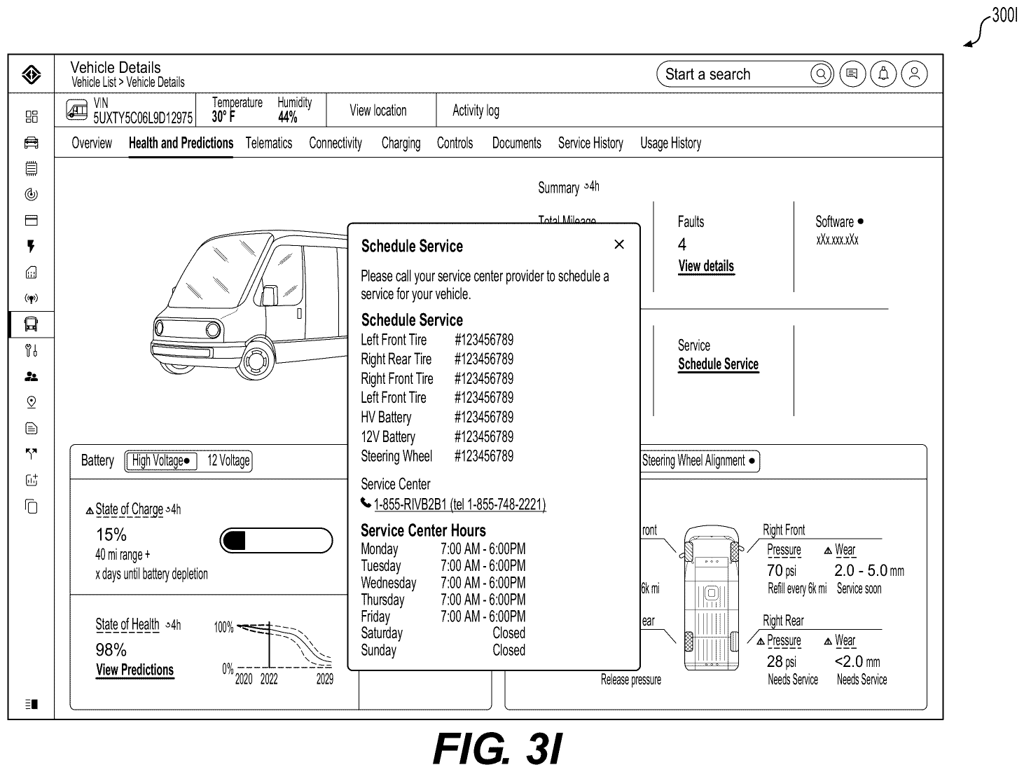

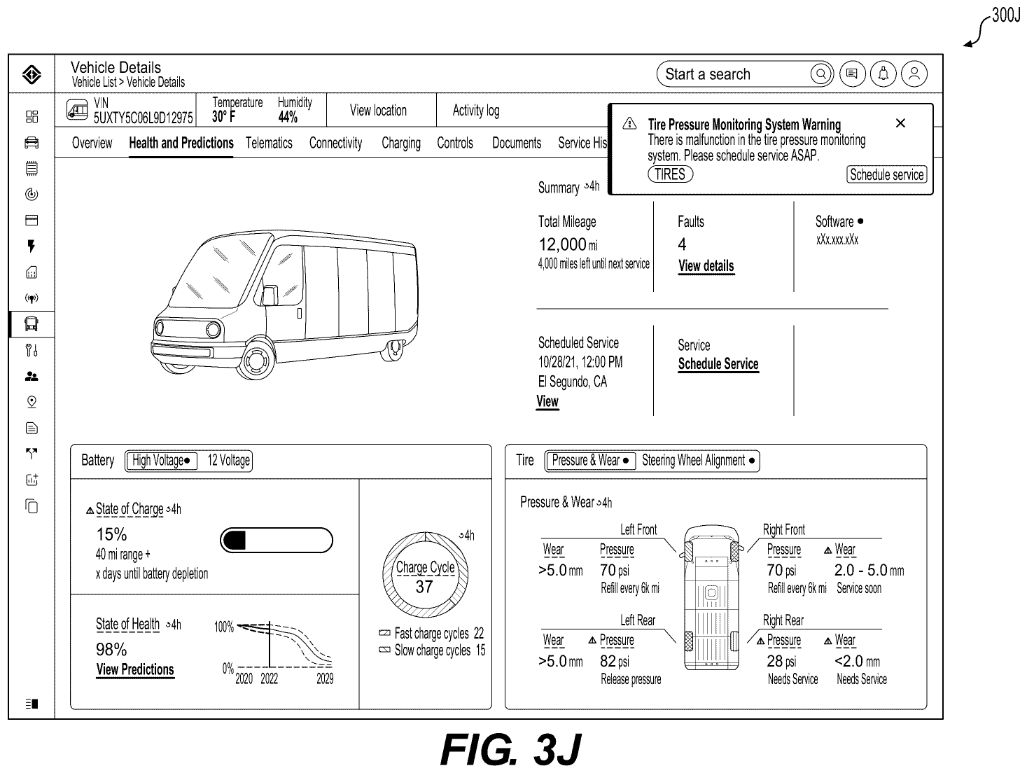

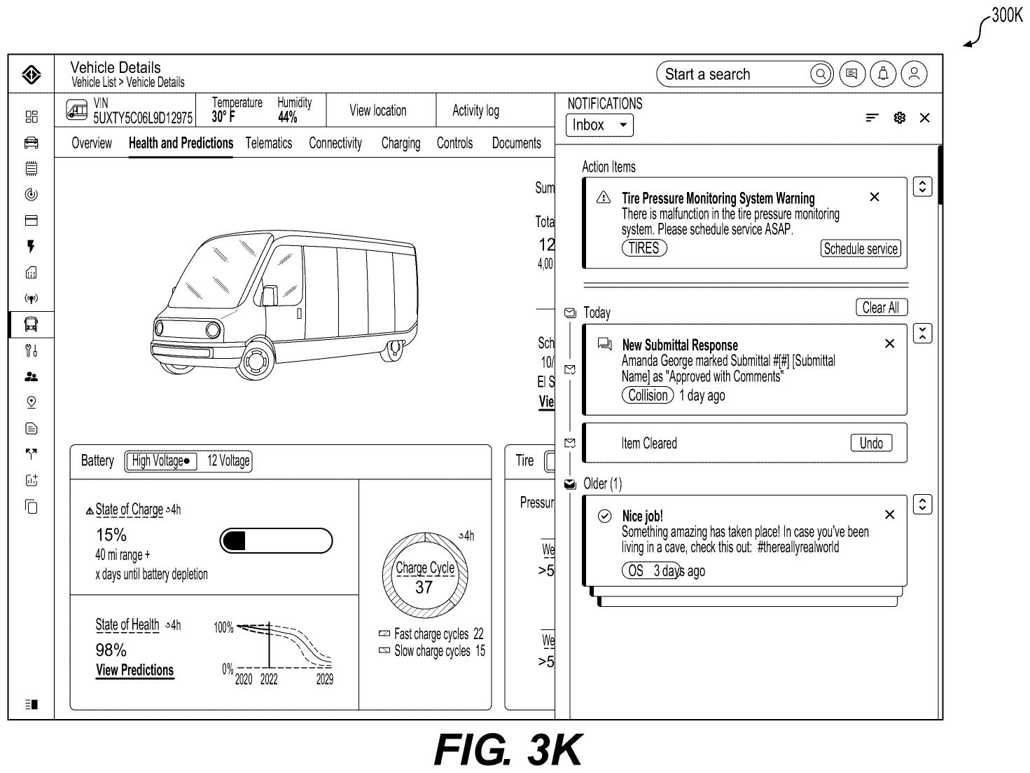

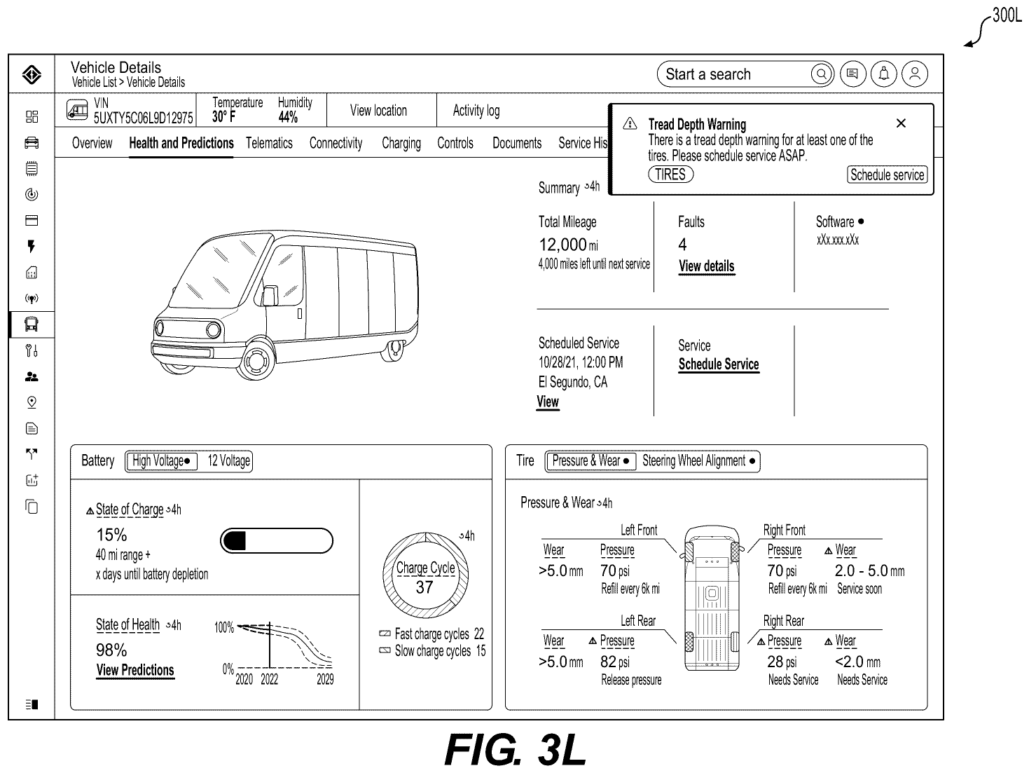

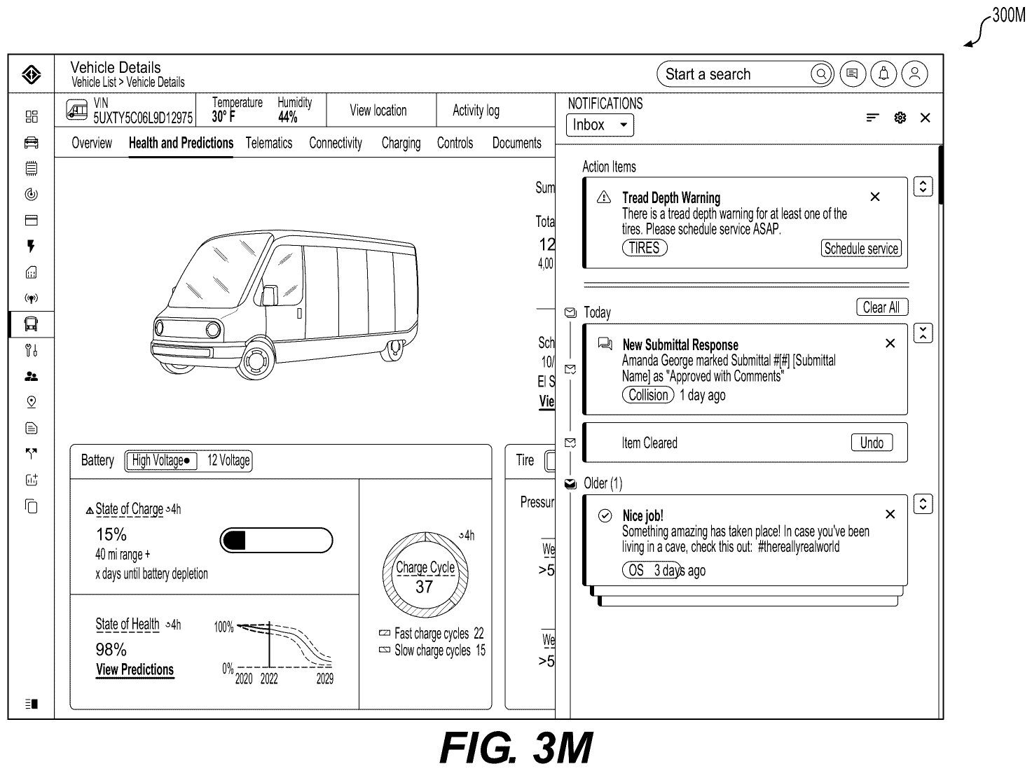

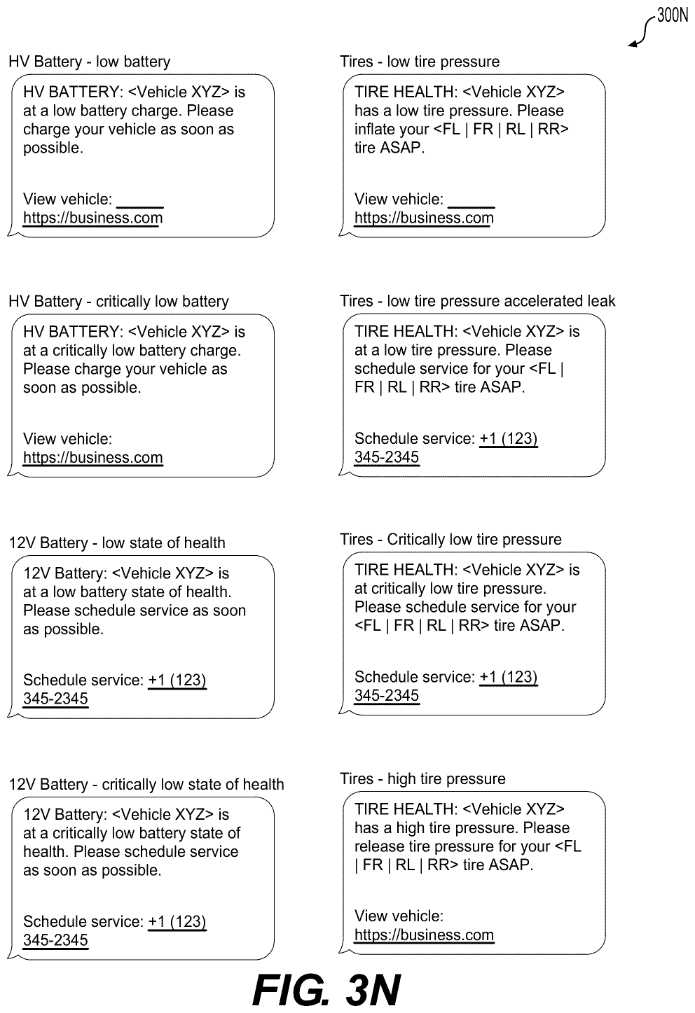

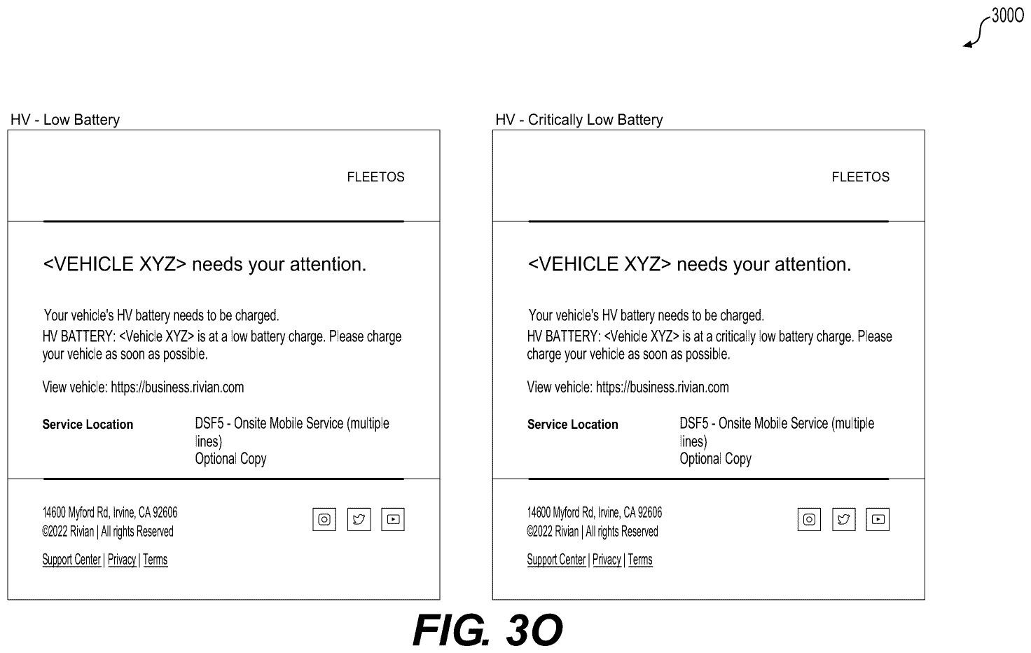

FIGS. 3A-3O illustrate one or more example screenshots of a UI 300A, 300B, 300C, 300D, 300E, 300F, 300G, 300H, 300I, 300J, 300K, 300L, 300M, 300N, and 300O or portions thereof for fleet management software, in accordance with the presently disclosed embodiments. At FIG. 3A, the fleet UI 300A may display a fault history of one or more vehicles 102 of the fleet of vehicles 102. For example, the fault history may include a visual and text-based log of all of the faults (e.g., tire fault, battery fault, HV battery fault, or other vehicle operational fault) experienced by a particular vehicle 102. At FIG. 3B, the fleet UI 300B may display predictions related to the current health of the vehicle 102. For example, as depicted, the predictions related to the current health of the vehicle 102 may include tire pressure and tire wear of each individual tire of the vehicle 102. At UI 300C of FIG. 3C, the predictions related to the current health of the vehicle 102 may include a current health indicator and prediction of end of life for the HV battery of the vehicle 102. At UI 300D of FIG. 3D, the predictions related to the current health of the vehicle 102 may include a prediction and current health of the HV battery and LV battery of the vehicle 102. At UI 300E of FIG. 3E, the fleet UI includes an example of a particular vehicle 102 in optimal current health (e.g., batteries and tires).

FIG. 3F illustrates that the fleet UI 300F may include one or more toggle buttons for toggling between tire pressure and wear and vehicle steering alignment. The UI 300G of FIG. 3G and UI 300H of FIG. 3H illustrate the tire pressure and wear and steering alignment indicators. The color indicators (e.g., green, red, and yellow) indicate different recommendation and/or warnings that may be provided by the fleet management system and fleet UI, in which green indicates no alerts for tire pressure and wear, yellow indicates that tire pressure and wear may be less than optimal, but no service is required, and red indicates that tire pressure and wear may be at or nearing critically low and service is required.

FIG. 3I illustrates that the fleet management system and fleet UI 300I may provide a pop-up indicator to schedule service, for example, when the tire pressure and wear is determined or predicted to be critically low. FIG. 3J illustrates that the fleet UI 300J may provide a tire wear pressure indicator. FIG. 3K illustrates that the fleet UI 300K may also include a log of all of the notifications that may be provided with respect to a particular vehicle 102, in which the notifications may be ranked and displayed according to most operationally-significant to least operationally-significant. For example, action items, such as scheduling and performing a service, may be ranked and displayed more conspicuously as compared, for example, to an advertisement. In some embodiments, the action items may include a user-selectable affordance that may link to a scheduling interface for scheduling the service indicated by the action item.

FIG. 3L illustrates that the fleet UI 300L may provide a tire wear indicator, for example, indicating a tire depth level. FIG. 3M illustrates another example UI 300M of the log of all of the notifications that may be provided with respect to a particular vehicle 102, in which the action item includes a user-selectable affordance that may link to a scheduling interface for scheduling a tire replacement, for example. FIGS. 3N and 3O illustrate that the fleet UI 300N, 300O may generate and provide, for example, one or more short message service (SMS) messages, multimedia message service (MMS) messages, or vehicle-to-everything (V2X) messages that may be generated and provided regarding the tire pressure and wear of the particular vehicle 102. In one embodiment, the SMS, MMS, or the V2X message may be generated and provided concurrently with any of the notifications discussed above.

Referring back, FIG. 3C illustrates an example UI 300C for presenting predictions associated with a high-voltage battery. In some embodiments, the user interface illustrated in FIG. GUI-2C is part of a user interface presented to a fleet manager who is managing a fleet of electric vehicle. In some embodiments, as illustrated, the user interface comprises a current state-of-health estimation, a state-of-health prediction in 12 months, an end of life prediction (e.g., in terms of time, in terms of mileage), a graph illustrating battery state-of-health vs. time, and user interfaces for providing inputs associated with parameters affecting battery state-of-health (e.g., state-of-charge, Depth of Discharge, rate of charge, temperature, rate of consumption, driver behavior).

The end of life of a battery may correspond to a battery's state-of-health being below a threshold level (e.g., 80%, 60%, 40%, 20%). After the end of life of the battery, the battery may be repurposed to provide energy for other devices (e.g., other than the electric vehicle). The graph comprises a first portion that illustrates the estimated battery state-of-health in the past and present and a second portion that illustrates the predicted battery state-of-health. It should be appreciated that the illustrated numbers are exemplary. It should be appreciated that the user interface may also be used for presenting predictions associated with a low-voltage battery.

In response to receiving inputs associated with parameters affecting battery state-of-health (via the user interface), the state of health prediction, end of life prediction, and the second portion of the graph may be updated based on the parameters. For example, if the rate of charging selected to be higher (via the user interface), the state of health prediction in 12 months may be lower, the end of life prediction may be earlier, and the second portion of the graph may be steeper downward. As another example, if the Depth of Discharge is selected to be greater (via the user interface), the state of health prediction in 12 months may be lower, the end of life prediction may be earlier, and the second portion of the graph may be steeper downward.

The predictions based on the varying parameters and user interface presenting the predictions advantageously allow a user (e.g., a fleet manager managing a fleet of electric vehicles) and/or an electronic device to optimize battery state-of-health for one or more electric vehicle in the future. For example, the user and/or the electronic device may plan the schedules of one or more vehicles based on parameters predicted to prolong the lifetime of a battery (e.g., a schedule that would reduce Depth of Discharge, a schedule that would reduce rate of charging, a schedule that would reduce stops).

The predictions based on the varying parameters and user interface presenting the predictions advantageously allow a user (e.g., a fleet manager managing a fleet of electric vehicles) and/or an electronic device to determine a more efficient schedule for the one or more electric vehicles. For example, a time for maintenance and/or repair may be more accurately predicted and scheduled. As a result, breakdown events may be prevented and/or more quickly addressed, reducing unplanned downtime for the electric vehicle (e.g., and allowing fleet schedule to be more closely followed). As another example, routes for the vehicles may be more efficiently determined. For instance, a vehicle with a lower estimated and/or predicted battery state-of-healthy may be assigned to shorter routes (to ensure the vehicle has sufficient available energy to complete the routes).

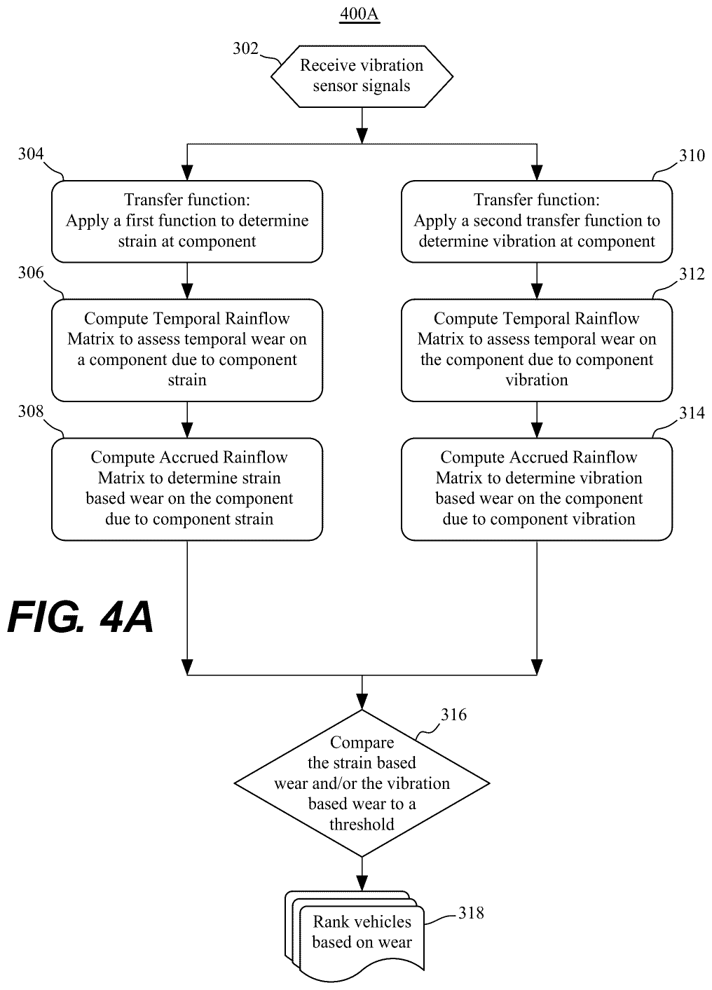

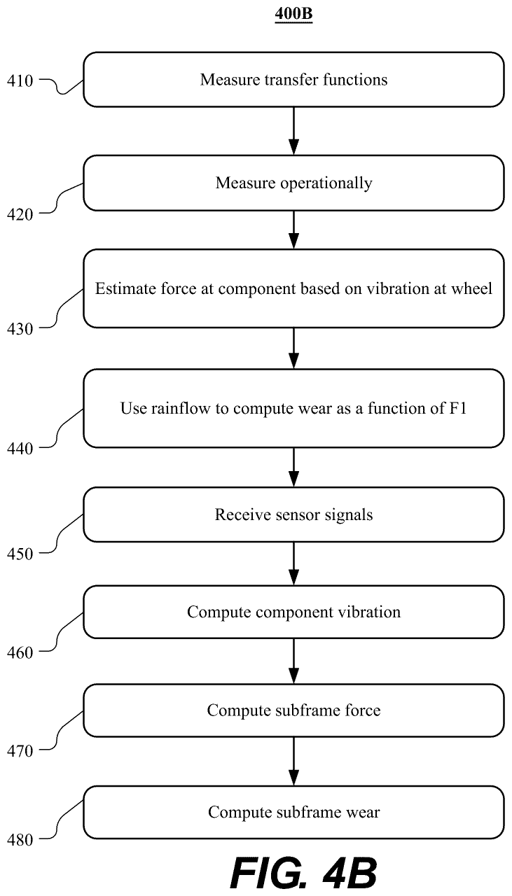

Referring now to FIG. 4A, a flowchart illustrating method 400A of computing wear for a vehicle and ranking a number of vehicles based on wear is shown, according to an exemplary embodiment. In certain embodiments, vehicles 1250 or 1260 (discussed in greater below) performs one or more steps of method 400A. Additionally or alternatively, one or more external systems, such as a cloud-based data processing system, may perform one or more steps of method 400A. For example, vehicles 1250 or 1260 may compute wear associated with vehicles 1250 or 1260 and a vehicle data analysis system may rank a number of vehicles based on the computed wear associated with each vehicle.

The strain-based wear and vibration-based wear accumulating on the component may be computed separately but in parallel. In both cases, a transfer function may be applied first to the incoming vibration sensor signals. A temporal rainflow matrix may be integrated into a constantly updating accrual rainflow matrix which is used to compute the final wear amounts. The wear may be compared against a threshold and a component having accumulated wear that exceeds the acceptable threshold may be identified for servicing.

At step 302, control system 230 may receive vibration sensor signals. For example, control system 230 may receive vibration sensor signals from vibration sensors 240 positioned on specific portions of vehicles 1250 or 1260. In certain embodiments, the vibration sensor signals include timeseries data. At step 304, control system 230 may apply a first transfer function to determine strain at a component of vehicles 1250 or 1260. For example, control system 230 may retrieve a transfer function corresponding to a specific vibration sensor 240 and component pair from a lookup table and may apply the transfer function to signals from the specific vibration sensor 240 to determine strain at the component.

Speaking generally, control system 230 may utilize one or more transfer functions that model a characteristic of vehicles 1250 or 1260 at a second location based on a characteristic of vehicles 1250 or 1260 at a first location. For example, control system 230 may utilize a first transfer function that models force on a portion of a component of vehicles 1250 or 1260 based on a measurement of vibrations at a wheel of vehicles 1250 or 1260. As another example, control system 230 may utilize a second transfer function that models vibration at a wheel strut based on a measurement of vibrations at a component of vehicles 1250 or 1260. In certain embodiments, the one or more transfer functions are determined based on operational measurements (e.g., measurements describing a relationship between vibration and strain, etc.).

In certain embodiments, determining strain includes computing a measurement of vibration at the component based on the vibration sensor signals. Additionally or alternatively, determining strain may include computing a measurement of force at the component based on the vibration sensor signals. For example, control system 230 may compute a measurement of vibration at a location on a component of vehicles 1250 or 1260 by applying a first transfer function to sensor signals from a vibration sensor positioned on a wheel of vehicles 1250 or 1260 and may compute a measurement of force at the location on the component by applying a second transfer function to the measurement of vibration at the location.

At step 306, control system 230 may compute a temporal rainflow matrix to assess temporal wear on a component due to component strain. For example, control system 230 may compute a number of fatigue cycles associated with a spring damper based on timeseries data describing force on the spring damper. In certain embodiments, the temporal rainflow matrix is associated with a time period. For example, the temporal rainflow matrix may represent an accumulation of fatigue cycles associated with a component over a 24-hour period. It should be understood that a different period may be used (e.g., 15 seconds, 1 hour, whenever connected to the Internet, etc.). In certain embodiments, the temporal rainflow matrix is an assembly of a number of fatigue cycles, an amplitude associated with the fatigue cycles, and/or a frequency of the fatigue cycles.

At step 308, control system 230 may compute an accrued rainflow matrix to determine strain-based wear on the component due to component strain. For example, control system 230 may compute an accrued number of fatigue cycles associated with a component of vehicles 1250 or 1260 over a lifetime of the component. In some embodiments, step 308 includes querying an external system, such as a vehicle data analysis system, to retrieve a first measurement of fatigue cycles associated with a first time period and adding a second measurement of fatigue cycles associated with a second time period to determine the strain-based wear. Additionally or alternatively, vehicles 1250 or 1260 may store a running count of fatigue cycles associated with one or more components. In certain embodiments, the strain-based wear includes an aggregate number of fatigue cycles and an amplitude associated with the fatigue cycles corresponding to the component. In some embodiments, control system 230 compares the aggregate number of fatigue cycles and the amplitude associated with the fatigue cycles to a value associated with component failure to determine a percentage of lifetime remaining associated with the component. In some embodiments, the value associated with component failure is determined experimentally (e.g., via coupon testing, etc.).

At step 310, control system 230 may apply a second transfer function to determine vibrations at the component. For example, control system 230 may retrieve a transfer function corresponding to a specific vibration sensor 240 and component pair from a lookup table and may apply the transfer function to signals from the specific vibration sensor 240 to determine vibrations at the component. At step 312, control system 230 may compute a temporal rainflow matrix to assess temporal wear on the component due to component vibration. For example, control system 230 may compute a number of fatigue cycles associated with the component and an amplitude of the fatigue cycles based on the vibration at the component.

At step 314, control system 230 may compute an accrued rainflow matrix to determine vibration-based wear on the component due to component vibration. For example, control system 230 may sum a number of fatigue cycles associated with a component that were accumulated over a 24-hour period with a number of fatigue cycles associated with the component accumulated before the 24-hour period. In embodiments where vehicles 1250 or 1260 is an electric vehicle, step 316 may occur in response to control system 230 sensing that vehicles 1250 or 1260 have been connected to a charger. In some embodiments, control system 230 compares the aggregate number of fatigue cycles and the amplitude associated with the fatigue cycles to a value associated with component failure to determine a percentage of lifetime remaining associated with the component.

At step 318, control system 230 may compare the strain-based wear to a threshold. For example, control system 230 may compare an aggregate number of fatigue cycles associated with the component over the lifetime of the component to a threshold to determine whether the aggregate number of fatigue cycles exceed the threshold. Additionally or alternatively, control system 230 may compare the vibration-based wear to a threshold. In certain embodiments, control system 230 uses a first threshold for comparing strain-based wear and a second threshold for comparing vibration-based wear. In certain embodiments, if the vibration-based wear and/or strain-based wear exceeds the threshold, control system 230 generates an alert. The alert may trigger additional actions such as automatically scheduling a service appointment to service the component. In some embodiments, the first and second thresholds are determined experimentally (e.g., via coupon testing, etc.). Additionally or alternatively, the first and second thresholds may be determined using an AI model trained with historical service data.

At step 318, a vehicle data analysis system may rank vehicles based on wear. For example, the vehicle data analysis system may query a ledger containing one or more vehicle health metrics associated with a fleet of vehicles and may rank the vehicles in the fleet from most wear to least wear. In some embodiments, step 318 includes aggregating one or more wear metrics associated with a number of components of a vehicle into a single wear metric representing the overall vehicle. For example, a vehicle data analysis system may track wear associated with 100 vehicle components of a vehicle and may generate an average wear metric for the vehicle by computing an average of the 100 component wear metrics. In certain embodiments, the vehicle data analysis system ranks the vehicles based on the average wear metric. Additionally or alternatively, the vehicle data analysis system may rank the vehicles based on individual component wear metrics.

FIG. 4B illustrates a method 400B of computing component wear for a vehicle, according to an exemplary embodiment. Method 400B may be used to perform background monitoring of a component of vehicles 1250 or 1260. A vibration sensor may be coupled to the component. An output of a first vibration sensor may be represented by {A_{FD}}. An output of a second vibration sensor 406 may be represented by {A_{W}}. In some embodiments, a force corresponding to a wheel is calculated based on the output a vibration sensor. The force corresponding to the wheel may be represented by {F_{W}}. The vibration sensors may be used to monitor a portion of a component for wear. For example, method 400B may be used to identify a crack a portion of a component. The force and vibration at the portion of the component may be represented as {F₁} and {A₁} respectively.

At step 410, one or more transfer functions may be measured. A transfer function may describe a relationship between vibration at a first location (e.g., the location of a first vibration sensor, etc.) and vibration at a second location (e.g., the location of the portion the component, etc.). However it should be understood that transfer functions representing other relationships are possible. For example, a transfer function may describe a relationship between vibration at a first location and force at a second location. The one or more transfer functions may be represented as:

$$\frac{\{ {A}_{1} \}}{\{ {A}_{W} \}} \frac{\{ {A}_{W} \}}{\{ {F}_{1} \}} \frac{\{ {A}_{FD} \}}{\{ {F}_{1} \}} \frac{\{ {A}_{1} \}}{\{ {A}_{FD} \}}$$

At step 420, an output of a vibration sensor may be measured. In some embodiments, step 420 includes calculating a force at a wheel based on vibration measurements at the wheel. At step 430, an estimate of force at a portion of a component may be estimated based on vibration at the wheel. For example, control system 230 may compute an estimate of force at a portion of a component by applying a transfer function to vibration data from a vibration sensor. In some embodiments, an output of step 430 includes timeseries force data corresponding to force experienced by the portion of the component over time. In certain embodiments, step 430 includes implementing the function:

$$\{ {F}_{1} \} = \{ {A}_{W} \} \frac{\{ {F}_{1} \}}{\{ {A}_{W} \}} = \{ {A}_{W} \} \frac{\{ {F}_{W} \}}{\{ {A}_{1} \}}$$

At step 440, control system 230 may compute wear associated with the portion of the component using the force computed in step 430. In certain embodiments, step 440 includes calculating a rainflow matrix based on the force. For example, control system 230 may sum a number of fatigue cycles generated from timeseries force data. In some embodiments, wear is expressed as a percentage of a threshold number of fatigue cycles. In certain embodiments, control system 230 performs steps 440-480. At step 450, control system 230 may receive vibration data from a vibration sensor. At step 460, control system 230 may compute component vibration using the vibration data from the vibration sensor. In certain embodiments, step 460 includes applying a transfer function to the vibration data from the vibration sensor. For example, control system 230 may implement the function:

$$\{ {A}_{1} \} = \{ {A}_{FD} \} \frac{\{ {A}_{1} \}}{\{ {A}_{FD} \}}$$

At step 470, control system 230 may compute component force for the portion of the component using the vibration data from the vibration sensors. In certain embodiments, step 470 includes applying a transfer function to the vibration data from a vibration sensor. For example, control system 230 may implement the function:

$$\{ {F}_{1} \} = \{ {A}_{FD} \} \frac{\{ {F}_{1} \}}{\{ {A}_{FD} \}}$$

At step 480, control system 230 may compute component wear based on the component force computed in step 470. In certain embodiments, step 480 includes calculating a rainflow matrix based on the force. For example, control system 230 may sum a number of fatigue cycles generated from timeseries force data. In some embodiments, wear is expressed as a percentage of a threshold number of fatigue cycles. In some embodiments, step 480 includes combining the measure of wear associated with the portion of the component generated from vibration data from a first vibration sensor with the measure of wear associated with the portion of the component generated from vibration data from a second vibration sensor. For example, control system 230 may compute an average wear using the two measurements of wear. In some embodiments, steps 420-440 are performed in parallel with steps 450-480.

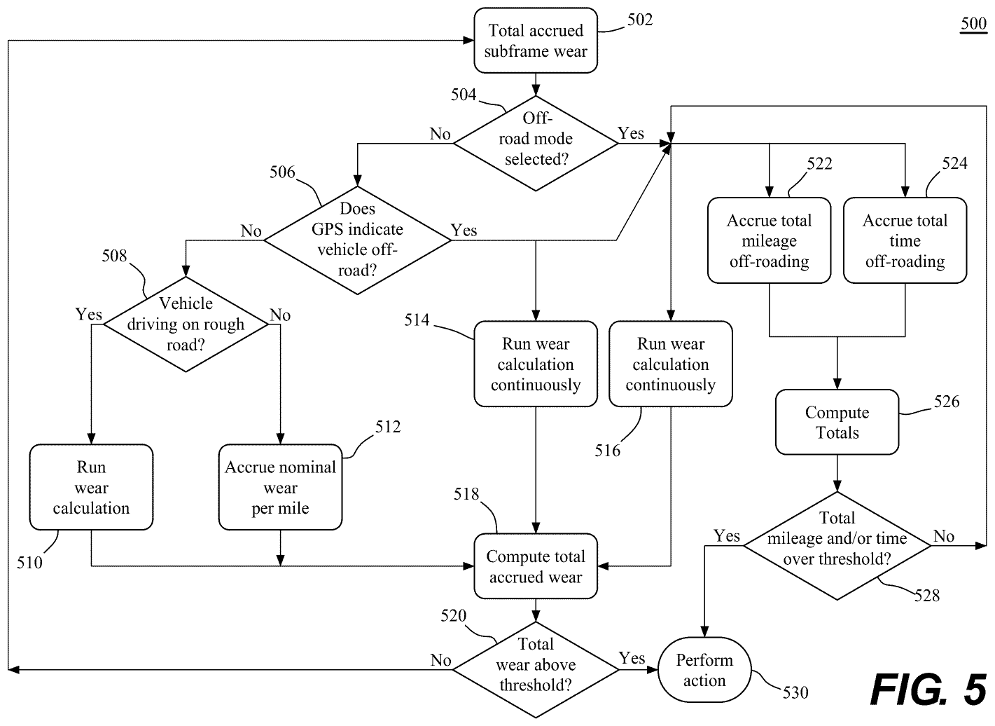

FIG. 5 is a flowchart illustrating a method 500 of monitoring wear for a vehicle. For example, control system 230 may implement method 500 to continuously monitor wear associated with one or more components of vehicles 1250 or 1260. Starting with the total accrued component wear calculated from the above description, a determination may be made to determine whether the vehicle is currently in an off-road environment. Using the off-road mode of the vehicle as an initial indicator, a vehicle in this mode may result in both a wear calculation and an off-road mileage and time calculation. These accrued totals may then be compared against thresholds representing acceptable threshold values, and exceeding either threshold may result in the trigger of a diagnostic trouble code (DTC) to notify the customer of a potential problem and a need for service. On the other hand, if the off-road mode of the vehicle is not enabled, the vehicle's GPS may be utilized to determine the road conditions the vehicle is currently subjected to. Indications of off-road conditions may result in actual wear calculations, whereas only nominal wear calculations are performed otherwise. In both conditions, the computed total wear is subsequently compared against the threshold and may also in turn result in the trigger of a DTC.

At step 504, control system 230 may determine whether an off-road mode is selected. For example, the TCM ECU may query the CGM ECU to determine what mode vehicles 1250 or 1260 is in. If the off-road mode is selected (yes), method 500 may continue with steps 516, 522, and 524. At step 516, control system 230 may run wear calculations continuously. For example, control system 230 may execute a method of monitoring component wear as described in detail above. At step 518, control system 230 may compute total accrued wear based on the wear calculation from step 516. For example, control system 230 may compute a rainflow matrix representing a total number of accrued fatigue cycles associated with a vehicle and/or a vehicle component over its lifetime. At step 520, control system 230 may compare the total accrued wear from step 518 with a threshold. If the total accrued wear is less than the threshold (no), then control system 230 may save the total accrued component wear (step 502). If the total accrued wear is greater than the threshold (yes), then control system 230 may perform an action (step 530). The action may include automatically scheduling a service appointment to service a component determined to have exceeded a threshold level of wear. Additionally or alternatively, the action may include alerting service personnel that the vehicle requires service.

At step 522, control system 230 may accrue total mileage off-roading. For example, control system 230 may update a counter to determine the number of miles driven in the off-road mode. At step 524, control system 230 may accrue total time off-roading. For example, control system 230 may update a timer to determine the total time spent in the off-road mode. At step 526, control system 230 may compute totals. For example, control system 230 may compute a total amount of mileage driven off-road and/or a total amount of time spent off-roading. At step 528, control system 230 may compare the total mileage and/or the total time to a threshold. In some embodiments, control system 230 compares the total mileage to a first threshold and the total time to a second threshold. If the total mileage and/or the total time are greater than a threshold (yes), then control system 230 may perform an action (step 530). For example, control system 230 may alert a user that a service appointment is recommended based on the total number of miles driven off-road. If the total mileage and/or total time are less than a threshold (no), then control system 230 may continue monitoring wear, mileage, and/or time associated with off-roading.

If the off-road mode is not selected (no), method 500 may continue with step 506. At step 506, control system 230 may determine whether GPS data indicates the vehicle is off-road. For example, control system 230 may compare a GPS location of vehicles 1250 or 1260 to a map of known roads to determine whether vehicles 1250 or 1260 are on one of the known roads. If the GPS data indicates that the vehicle is off-road (yes), then control system 230 may perform the off-road monitoring described above (e.g., steps 516, 522, and 524). If the GPS data indicates that the vehicle is not off-road (no), then control system 230 may determine whether the vehicle is driving on a rough road (step 508). For example, control system 230 may compare an amplitude of vibration data signals to a threshold and determine that the vehicle is driving on a rough road if the amplitude of the vibration data signals exceed the threshold a threshold number of times during a period.

If control system 230 determines that the vehicle is driving on a rough road (yes), then control system 230 may run a wear calculation continuously (step 510). Running the wear calculation may include computing a rainflow matrix to determine an aggregate number of fatigue cycles based on vibration data as described in detail above. If control system 230 determines that the vehicle is not driving on a rough road (no), then the control system may accrue nominal wear per mile (step 512). For example, control system 230 may add a scalar value to a rainflow matrix for each mile traveled by the vehicle. In certain embodiments, control system 230 performs step 518 after steps 510 and 512.

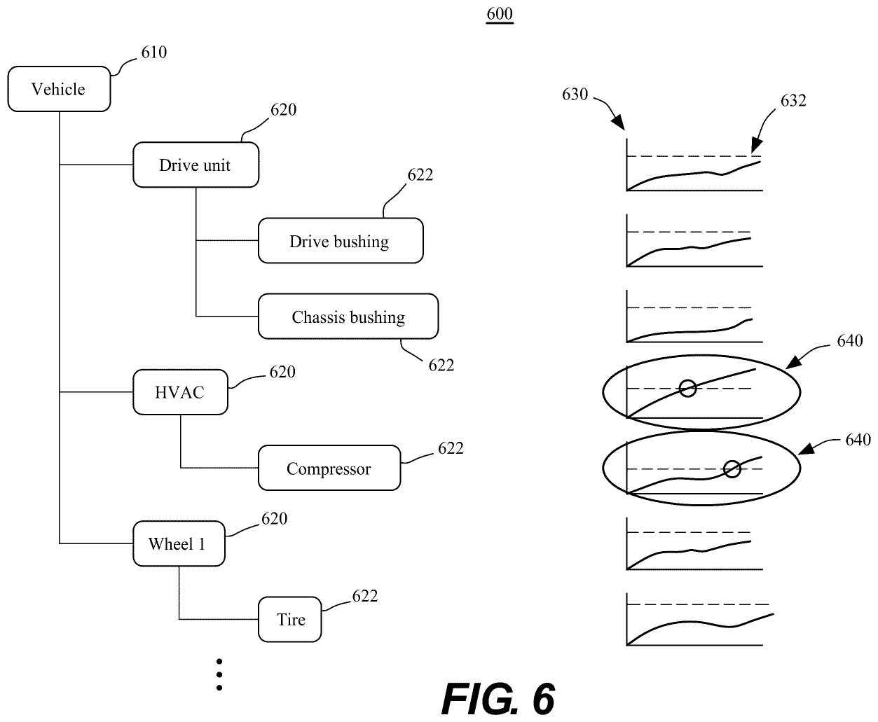

Turning now to FIG. 6, an example of monitoring component wear for a vehicle and identifying a component in need of service is shown, according to an exemplary embodiment. In certain embodiments, a vehicle data analysis system and/or on-board module may maintain data structure 600 (e.g., a ledger, etc.) for a number of vehicles. Data structure 600 may be a digital representation of each vehicle and/or the components of each vehicle. For example, data structure 600 may include an entry for vehicle 610 having components 620 and sub-components 622. In certain embodiments, the vehicle data analysis system may continuously monitor wear associated with each of components 620 and/or subcomponents 622. For example, the vehicle data analysis system may apply a transfer function to vibration data to determine a measure of strain at each component 620 and may compute a rainflow matrix using the measure of strain to determine wear associated with each component 620.

In certain embodiments, data structure 600 includes wear measurements 630. Wear measurements 630 may represent the results of a rainflow matrix describing a number of accumulated fatigue cycles associated with each component 620 and/or subcomponent 622. In certain embodiments, components 620 and/or subcomponents 622 may accumulate wear at different rates. In some embodiments, the vehicle data analysis system may compare wear measurements 630 to threshold 632. In certain embodiments, if a wear measurement associated with a component exceeds the threshold, the vehicle data analysis system may perform an action. For example, the vehicle data analysis system may automatically schedule a service appointment to service the component. In some embodiments, the vehicle data analysis system may identify components in need of repair 640 based on comparing wear measurements 630 to thresholds 632.

For example, the vehicle data analysis system may identify components in need of repair 640 based on wear measurements 630 exceeding thresholds 632. Additionally or alternatively, the vehicle data analysis system may identify components in need of repair 640 based on a rate of wear accumulation. For example, if a first component starts to accumulate wear quickly (e.g., accelerated wear) then the vehicle data analysis system may identify the first component (and/or a second component) as in need of repair. In certain embodiments, thresholds 632 are unique to each component 620 and/or subcomponent 622. For example, a drive bushing may have a first threshold and a chassis bushing may have a second threshold. In certain embodiments, wear measurements 630 may be aggregated to generate an overall wear metric for vehicle 610. Additionally or alternatively, wear measurements 630 corresponding to sub-components 622 may be aggregated to generate an overall wear measurement for components 620. For example, a wear measurement for a drive unit may be computed as an average of wear measurements for subcomponents of the drive unit.

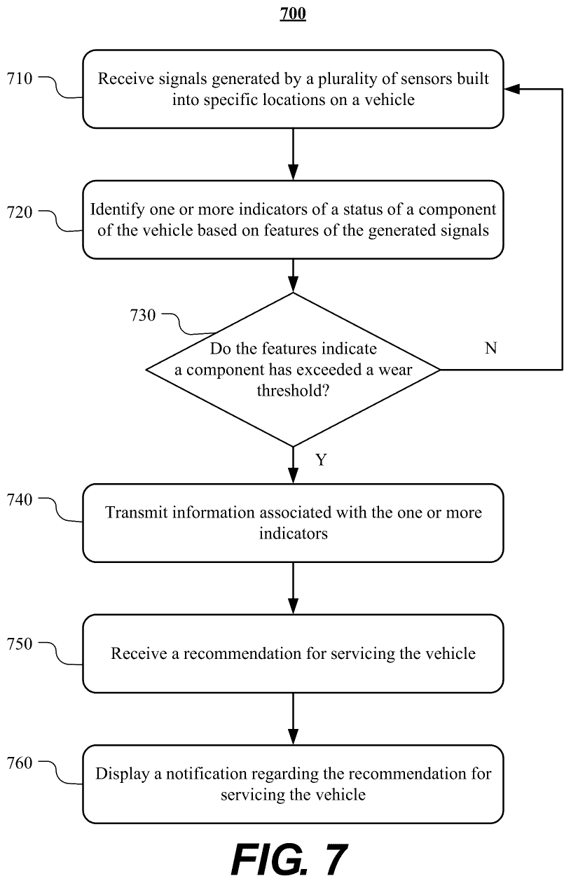

Turning now to FIG. 7, a flowchart illustrating a method 700 of determining a maintenance schedule for a vehicle is shown, according to an exemplary embodiment. In certain embodiments, an on-board module of vehicles 1250 or 1260 performs method 700. For example, the TCM ECU may perform method 700. Additionally or alternatively, a cloud-based data processing system such as a vehicle data analysis system may perform one or more steps of method 700. Method 700 is described with reference to an on-board module of vehicles 1250 or 1260, however it should be understood that method 700 may be performed by any other data processing system.

At step 710, an on-board module may receive signals generated by a number of sensors built into specific locations on a vehicle. In certain embodiments, the number of sensors include vibration sensors. For example, the on-board module may receive vibration data from a number of accelerometers positioned on a component of vehicles 1250 or 1260. In some embodiments, step 710 includes receiving microphone data. Additionally or alternatively, step 710 may include receiving signals describing an operation of vehicles 1250 or 1260. For example, the signals may include steering angle data, throttle/brake pedal apply data, wheel speed data, and/or drive unit speed/torque data.

At step 720, the on-board module may identify one or more indicators of a status of a component of the vehicle based on features of the generated signals. For example, the on-board module may perform frequency analysis to identify a frequency signature corresponding to a vibrating component. As another example, the on-board module may compute a cepstrum of vibration data with respect to a rotational speed of a drive unit of vehicles 1250 or 1260 and may apply a peak picking filter to the cepstrum to identify a frequency related to a damaged bearing. In some embodiments, step 720 includes applying a transfer function to vibration data. Additionally or alternatively, step 720 may include computing a rainflow matrix using vibration data to generate a measurement of wear associated with a component.

At step 730 the on-board module may determine whether the features indicate a component has exceeded a wear threshold. For example, the on-board module may determine that a component has exceeded a wear threshold based on identifying a frequency signature from audio data associated with a damaged gear. In some embodiments, step 730 includes comparing a measurement of wear to a threshold as described above. If the features indicate that a component has not exceeded a wear threshold (no), then method 700 may continue with step 710. If the features indicate that a component has exceeded a wear threshold (yes), then method 700 may continue with step 740.

At step 740, the on-board module may transmit information associated with the one or more indicators. For example, the on-board module may transmit a wear measurement associated with a component of vehicles 1250 or 1260. As another example, the on-board module may transmit a portion of vibration data. In certain embodiments, step 740 includes transmitting the information to a cloud-based data processing system. For example, step 740 may include transmitting microphone data and throttle pedal position data to a vehicle data analysis system.

At step 750, the on-board module may receive a recommendation for servicing the vehicle. For example, the on-board module may receive a recommendation to service a drive unit gear. In certain embodiments, the recommendation is received from a cloud-based data processing system (e.g., a vehicle data analysis system). In certain embodiments, the recommendation is based on a prediction related to the one or more indicators and is identified by a vehicle data analysis system using a ML model trained to predict component failures using historical vehicle service data. For example, a vehicle data analysis system may train a CNN autoencoder using historical vehicle service data and/or historical vibration data and may be executed using vibration data from a vehicle to identify a component of the vehicle in need of service. At step 760, the on-board module may display a notification regarding the recommendation for servicing the vehicle. For example, the on-board module may cause a display of vehicles 1250 or 1260 to display a notification informing a user that service is required and allowing the user to select from a number of available service appointments. In some embodiments, step 760 includes automatically scheduling a service appointment based on the recommendation from step 750.

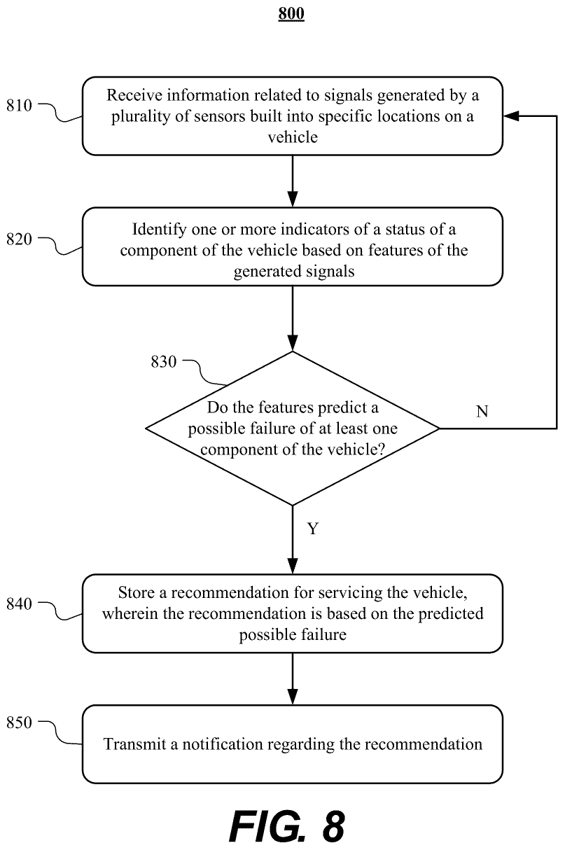

Turning now to FIG. 8, a flowchart illustrating a method 800 of generating a recommendation for servicing a vehicle is shown, according to an exemplary embodiment. In certain embodiments, method 800 is performed by a cloud-based data processing system (e.g., a vehicle data analysis system, etc.). At step 810, the vehicle data analysis system may receive information related to signals generated by a plurality of sensors built into specific portions of a vehicle. In certain embodiments, the sensors include a vibration sensor. For example, the vehicle data analysis system may receive vibration data from a number of accelerometers positioned on a component of vehicles 1250 or 1260. In some embodiments, step 810 includes receiving microphone data. Additionally or alternatively, step 810 may include receiving signals describing an operation of vehicles 1250 or 1260. For example, the signals may include steering angle data, throttle/brake pedal apply data, wheel speed data, and/or drive unit speed/torque data.

At step 820, the vehicle data analysis system may identify one or more indicators of a status of a component of the vehicle based on features of the generated signals. In some embodiments, step 820 includes performing frequency analysis on the generated signals. As another example, the vehicle data analysis system may compute a cepstrum of vibration data with respect to a rotational speed of a drive unit of vehicles 1250 or 1260 and may apply a peak picking filter to the cepstrum to identify a frequency related to a damaged bearing. In some embodiments, step 820 includes analyzing the generated signals using an AI model trained using historical sensor data. In some embodiments, step 820 includes applying a transfer function to vibration data. Additionally or alternatively, step 820 may include computing a rainflow matrix using vibration data to generate a measurement of wear associated with a component.

At step 830, the vehicle data analysis system may determine whether the features predict a possible failure of at least one component of the vehicle. For example, the vehicle data analysis system may compare a measure of accumulated wear associated with a component to a threshold. If the features do not predict a possible failure (no), then method 800 may continue at step 810. If the features predict a possible failure (yes), then method 800 may continue at step 840. At step 840, the vehicle data analysis system may store a recommendation for servicing the vehicle. In some embodiments, the recommendation is based on the predicted possible failure. For example, the vehicle data analysis system may store a recommendation for replacing a bearing in a drive unit of a vehicle based on predicting that the bearing is likely to fail soon (e.g., because a measure of accumulated wear associated with the bearing has exceeded a threshold, etc.). In some embodiments, step 840 includes automatically scheduling a service appointment based on the recommendation.

At step 850, the vehicle data analysis system may transmit a notification regarding the recommendation. For example, the vehicle data analysis system may transmit a notification to the vehicle to notify a user that a component associated with the recommendation requires servicing. In some embodiments, step 850 includes receiving user input in response to the notification. For example, the notification may allow a user to select between a number of available service appointments and step 850 may include receiving a user selection of an available service appointment from the number of available service appointments.

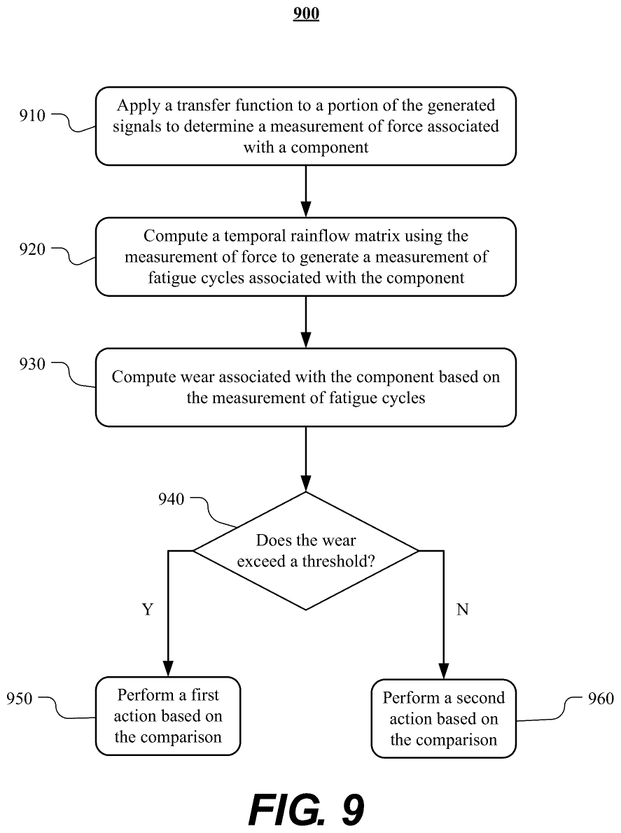

Turning now to FIG. 9, a flowchart illustrating a method 900 of monitoring component wear for a vehicle is shown, according to an exemplary embodiment. In certain embodiments, an on-board module of vehicles 1250 or 1260 performs method 900. Additionally or alternatively, a vehicle data analysis system may perform method 900. At step 910, the on-board module may apply a transfer function to a portion of the generated signals to determine a measurement of force associated with a component. For example, the on-board module may apply a transfer function as described above to convert vibration data measured at a first location associated with a vibration sensor into a measurement of force at a second location associated with the component.

At step 920, the on-board module may compute a temporal rainflow matrix using the measurement of force to generate a measurement of fatigue cycles associated with the component. For example, the on-board module may sum a number of fatigue cycles accumulated over a 24-hour period. In certain embodiments, the temporal rainflow matrix includes a number of fatigue cycles, an amplitude associated with the fatigue cycles, and/or a frequency of the fatigue cycles. At step 930, the on-board module may compute wear associated with the component based on the measurement of fatigue cycles. In some embodiments, step 930 includes comparing the measurement of fatigue cycles to a threshold. In some embodiments, step 930 includes computing a measurement of aggregate wear associated with the component. For example, the on-board module may sum a number of fatigue cycles accumulated over a 24-hour period to a number of fatigue cycles accumulated prior to the 24-hour period. In some embodiments, wear is expressed as a percentage of a threshold value.

At step 940, the on-board module may determine whether the wear exceeds a threshold. For example, the on-board module may compare an aggregate number of fatigue cycles to a threshold number of fatigue cycles. Additionally or alternatively, the on-board module may compare an amplitude associated with a number of fatigue cycles to a threshold amplitude. If the wear exceeds the threshold (yes), then method 900 may continue with step 950. At step 950, the on-board module may perform a first action. For example, the on-board module may generate an alert to notify a user that the component requires servicing. Additionally or alternatively, the on-board module may automatically schedule a service appointment to have the component serviced. In some embodiments, the first action includes a number of actions. For example, in response to determining that a drive unit gear has exceeded a threshold level of wear, the on-board module may adjust operation of vehicles 1250 or 1260 to avoid using the gear and may prompt a user of vehicles 1250 or 1260 to schedule a service appointment to service the gear.

If the wear does not exceed the threshold (no), then method 900 may continue with step 960. At step 960, the on-board module may perform a second action. For example, the on-board module may transmit the measurement of wear to an external system (e.g., vehicle data analysis system, etc.). In some embodiments, step 960 is omitted. For example, the on-board module may continuously monitor wear associated with components of vehicles 1250 or 1260 and may only perform an action if a component wear exceeds a threshold.

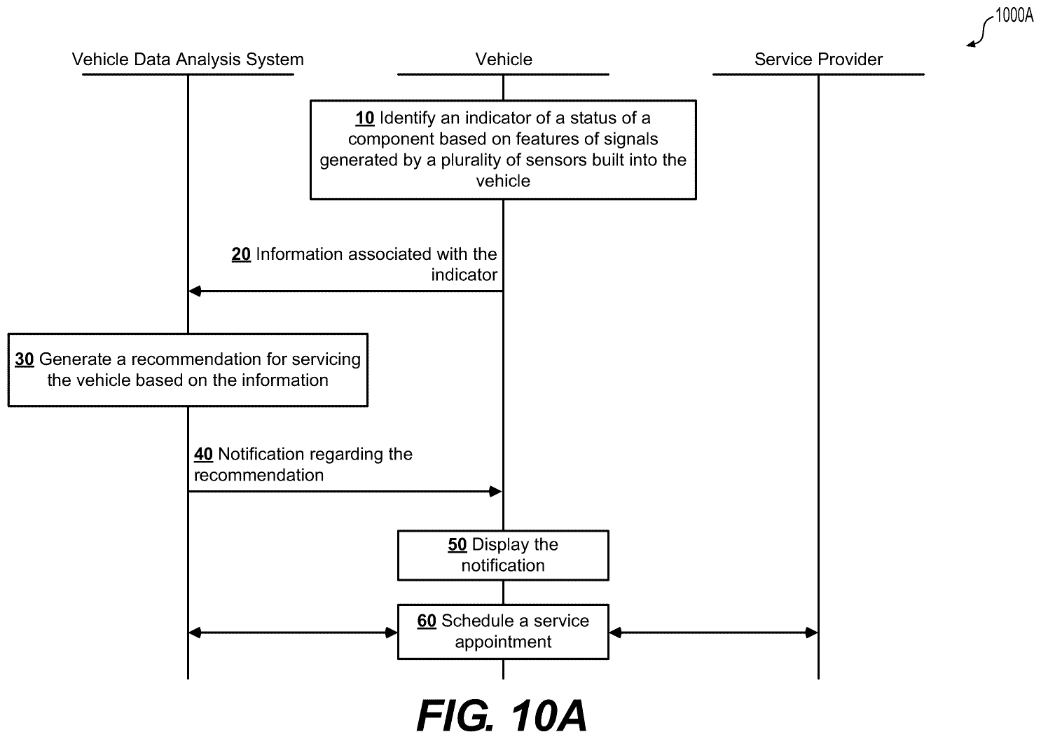

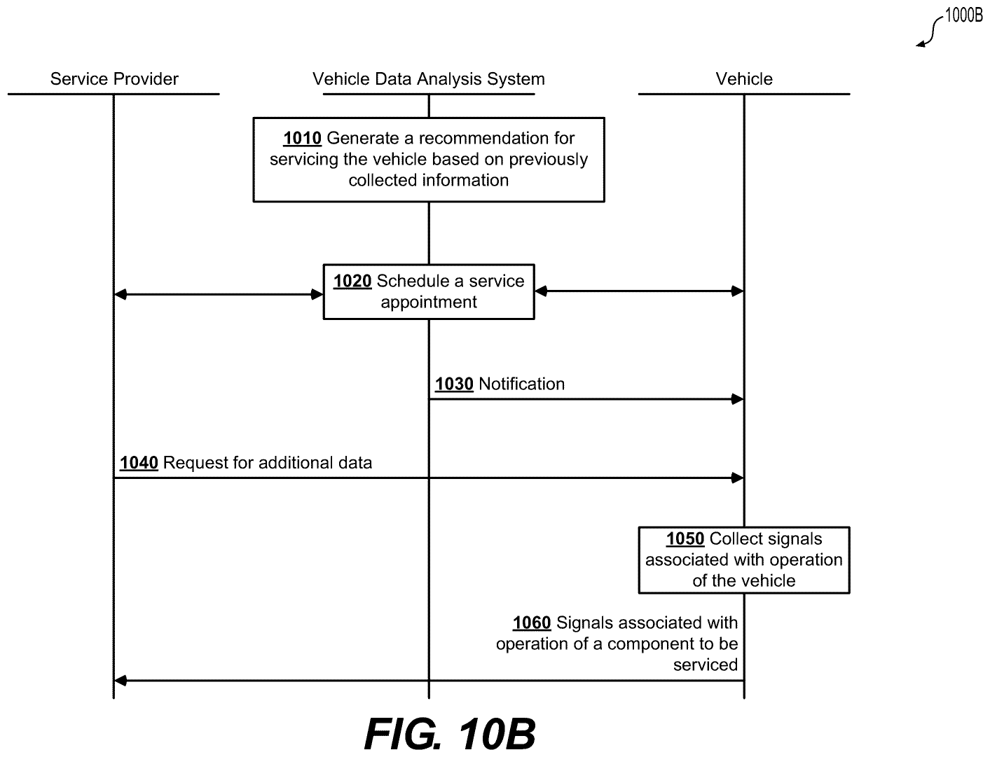

In FIG. 10A, a workflow diagram 1000A includes an example of generating a recommendation for servicing a vehicle and scheduling a service appointment based on the recommendation is shown, according to an exemplary embodiment. At step 10, a vehicle (e.g., an on-board module, etc.) may identify an indicator of a status of a component based on features of signals generated by a plurality of sensors built into the vehicle. For example, the vehicle may analyze data from a number of vibration sensors embedded in the vehicle to identify a frequency signature associated with a specific component of the vehicle (e.g., a specific gear of a drive unit, etc.). In some embodiments, an indicator (e.g., a vibration signature, etc.) of a component is identified by analyzing a cepstrum of vibration signals taken with respect to a rotational speed of a drive unit of the vehicle. Additionally or alternatively, the indicator may be identified using an AI model such as a convolutional neural network (CNN) autoencoder. In certain embodiments, the AI model is trained using historical operational data. For example, a CNN model may be trained using operation data including vibration signals labeled with an error state that they correspond to. In certain embodiments, the AI model is updated using subsequent sensor data. For example, a CNN model may be continuously updated using vibration data from a number of vehicles in a fleet. The indicator may be associated with wear on the vibrating component.

In certain embodiments, step 10 includes correlating signals from a number of sensors to identify the indicator. For example, the vehicle may identify a vibrating strut based on identifying a first frequency signature from FFT of signals from a first vibration sensor and identifying a second frequency signature from a FFT of signals from a second vibration sensor (wherein the first and second frequency signatures are correlated with the vibrating strut). Step 10 may include performing frequency analysis such as applying a peak picking filter to a cepstrum of vibration data taken with respect to a rotational speed of a drive unit. In some embodiments, step 10 includes computing wear associated with the vibrating component based on the signals. For example, the vehicle may compute a temporal rainflow matrix using the signals to assess temporal wear on the vibrating component. In some embodiments, the indicator is associated with a specific failure mode of the vibrating component. For example, step 10 may include differentiating between a damaged spline threading and a low-oil failure mode associated with a drive unit based on a vibration signature.

At step 20, the vehicle may transmit information associated with the indicator to a vehicle data analysis system (e.g., a cloud-based data processing system, etc.). For example, the vehicle may transmit a measurement of wear associated with the vibrating component. Additionally or alternatively, the information may include raw signal data from one or more of the plurality of sensors. For example, the vehicle may transmit raw signal data from a number of vibration sensors to the vehicle data analysis system for use in a machine learning (ML) model. The vehicle data analysis system may include one or more cloud-based data processing systems/servers that receive and analyze data from a number of vehicles.

At step 30, the vehicle data analysis system may generate a recommendation for servicing the vehicle based on the information. In certain embodiments, the vehicle data analysis system generates the recommendation using a ML model trained to predict component failures using historical vehicle service data. For example, the vehicle data analysis system may execute a CNN auto-encoder model trained using a corpus of sensor signals collected during operation of a number of vehicles. Additionally or alternatively, the vehicle data analysis system may generate the recommendation using one or more physics-based models.

For example, the vehicle data analysis system may compute an accrued rainflow matrix using a measurement of temporal wear received from the vehicle to determine aggregate wear associated with the vehicle and/or a vehicle component and may compare the aggregate wear to a threshold to determine whether the vehicle and/or vehicle component are in need of service. In certain embodiments, the recommendation may identify a specific component of the vehicle. For example, the recommendation may identify a specific gear of a drive unit in need of service (e.g., based on an aggregate wear associated with the gear exceeding a threshold, etc.). Additionally or alternatively, the recommendation may identify a specific failure mode associated with a component. For example, the vehicle data analysis system may generate a recommendation to repair a crack in a specific portion of a component of the vehicle.

At step 40, the vehicle data analysis system may transmit a notification regarding the recommendation. For example, the vehicle data analysis system may transmit information to cause the vehicle to display a graphical user interface (GUI) indicating that service is recommended for a specific component. In certain embodiments, the notification includes service information such as an estimated time required to perform a repair, an estimated cost of a repair, available appointment slots at service providers nearby, and/or the like.

At step 50, the vehicle may display the notification. For example, the vehicle may display a GUI recommending service for a specific component and allowing a user to choose from a number of available service appointments. At step 60, a service appointment is scheduled. In certain embodiments, step 60 includes querying a service provider with information associated with the recommended service (e.g., a type of service, components needed, etc.) to retrieve one or more available time slots. For example, the vehicle data analysis system may query the service provider for available time slots for a rear-left brake rotor replacement (e.g., specifying any parts required) and the service provider may return a list of available time slots corresponding to when a technician capable of performing the replacement and the required parts are available. In certain embodiments, step 60 includes displaying a number of available time slots to a user of the vehicle, receiving a selection from the user of a specific time slot, and/or automatically scheduling a service appointment based on the user selection.

FIG. 10B is a workflow diagram 1000B includes providing additional data associated with the operation of a vehicle to a service provider is shown, according to an exemplary embodiment. In certain embodiments, a service provider may request additional data to facilitate diagnosing a concern associated with a vehicle. For example, a user may schedule a service appointment for a vehicle component and the service provider may wish to collect additional data on the component before the user arrives at the service location. In certain embodiments, in response to receiving a request for additional data, the on-board module of vehicles 1250 or 1260 may transmit sensor signals.

At step 1010, the vehicle data analysis system may generate a recommendation for servicing the vehicle based on previously collected information. For example, the vehicle data analysis system may generate a recommendation based on comparing a measurement of wear associated with a component to a threshold as described in detail above. At step 1020, a service appointment may be scheduled. Step 1020 may include interaction between the service provider, the vehicle data analysis system, and/or the vehicle.

For example, the vehicle data analysis system may query a service provider for available service appointments, may transmit a list of the available service appointments to the vehicle, may receive a user selection of a service appointment from the list of available service appointments, and may transmit a request for a service appointment corresponding to the user selection to the service provider. In some embodiments, the vehicle data analysis system transmits information about a type of service requested and the service provider and/or other information associated with the service requested. For example, the vehicle data analysis system may transmit historical service information. As another example, the vehicle data analysis system may transmit sensor signals (or information derived therefrom) to the service provider to facilitate the service provider determining what service is required.

At step 1030, the vehicle data analysis system may transmit a notification to the vehicle. The notification may include information about the scheduled service appointment. For example, the notification may include a time, date, and location of the service appointment. Additionally or alternatively, the notification may include additional information such as an estimated time for completing the service and/or an estimated price. In some embodiments, a user of the vehicle can accept and/or decline the scheduled service appointment via the notification.

At step 1040, the service provider may transmit a request for additional data to the vehicle. For example, the vehicle data analysis system may schedule a service appointment related to excess noise associated with a drive unit of the vehicle and the service provider may request additional data such as vibration and/or sound data from the vehicle to facilitate determining what is causing the excess noise. In certain embodiments, the request for additional data specifies a specific component (or subcomponent, etc.) that additional data is requested for. Additionally or alternatively, the request may specify a type of data requested (e.g., vibration data, sound data, etc.). For example, the request may specify that vibration data associated with a wheel bearing is requested.

At step 1050, the vehicle may collect signals associated with operation of the vehicle. In certain embodiments, the vehicle collects the signals based on the request in step 1040. For example, if the request specified vibration data associated with a wheel bearing, then the vehicle may collect vibration data using a vibration sensor positioned on a component of the vehicle and may apply a transfer function to the vibration data to generate vibration data associated with the wheel bearing. In certain embodiments, the vehicle collects the signals during operation of the vehicle (e.g., while the vehicle is moving). For example, the vehicle may collect the signals while the user is driving the vehicle to the service appointment. Additionally or alternatively, the vehicle may collect the signals while the vehicle is stationary. For example, if the service provider requests vibration data associated with an AC compressor of the vehicle, the vehicle may operate the AC compressor while the vehicle is parked to collect the vibration data, thereby reducing noise in the signal corresponding to the AC compressor vibrations.

At step 1060, the vehicle may transmit signals associated with operation of a component to be serviced. For example, the vehicle may transmit vibration sensor associated with an AC compressor of the vehicle to the service provider. In certain embodiments, the vehicle transmits raw sensor data (e.g., timeseries accelerometer data, etc.) to the service provider. Additionally or alternatively, the vehicle may transmit information derived from the raw sensor data. For example, the vehicle may transmit vibration data associated with a component of the vehicle to the vehicle data analysis system which may analyze the data using a CNN autoencoder model and output a subcomponent of the component that is likely causing an issue, and the vehicle may transmit an indication of the subcomponent to the service provider. In certain embodiments, the service provider uses the signals received in step 1060 to determine what service to perform. For example, the service provider may analyze raw sensor signals received as part of step 1060, may identify a specific gear that needs replacing based on the analysis, and may replace the gear (e.g., rather than deconstructing and manually inspecting a component/subcomponent, etc.).

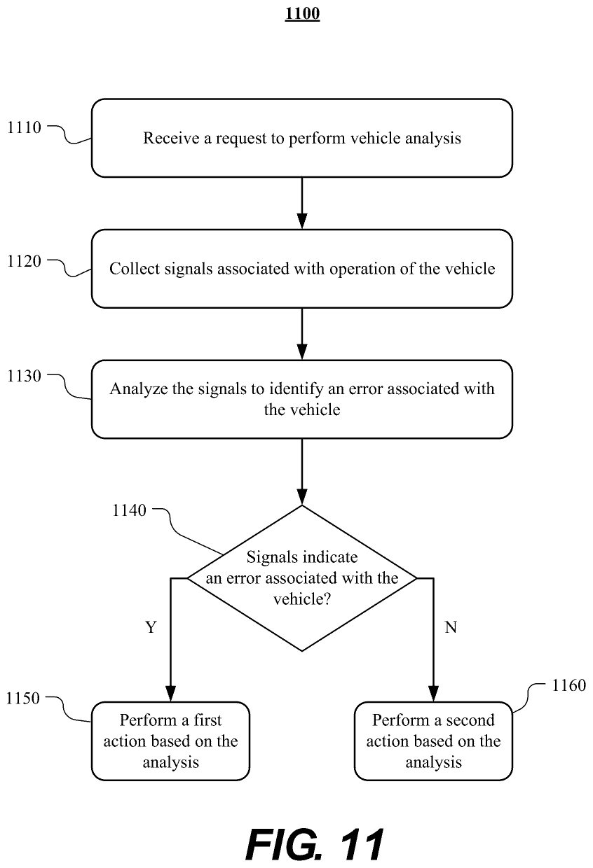

Turning now to FIG. 11, a flowchart illustrating a method 1100 of performing vehicle analysis is shown, according to an exemplary embodiment. Method 1100 may be part of a vehicle audit performed after vehicles 1250 or 1260 is manufactured but before vehicles 1250 or 1260 enters a marketplace. For example, method 1100 may be performed as part of a quality assurance program to ensure vehicles 1250 or 1260 is in proper working order before being shipped to a dealership for sale. In certain embodiments, an on-board module of vehicles 1250 or 1260 (e.g., the TCM ECU, etc.) performs method 1100.

At step 1110, the on-board module may receive a request to perform vehicle analysis. For example, a technician may select an audit option on a UI of vehicles 1250 or 1260. As another example, a quality assurance computing system may transmit a message to vehicles 1250 or 1260 to initiate vehicle analysis. At step 1120, the on-board module may collect signals associated with operation of the vehicle. For example, the on-board module may collect vibration data from a number of vibration sensors built into specific portions of vehicles 1250 or 1260. In certain embodiments, step 1120 includes applying a transfer function to the collected signals.

For example, the on-board module may collect vibration data from a vibration sensor positioned on a component of vehicles 1250 or 1260 and may apply a number of transfer functions to the vibration data to generate vibration data associated with a number of components of vehicles 1250 or 1260. In certain embodiments, the signals are associated with a health of the vehicle/vehicle components (e.g., vibration data, microphone data, data describing torque applied to a component of the vehicle, etc.). In certain embodiments, step 1120 includes collecting signals during different operating states of vehicles 1250 or 1260. For example, the on-board module may collect first signals while vehicles 1250 or 1260 is idling, second signals while vehicles 1250 or 1260 is traveling 35 miles-per-hour (MPH), and third signals while vehicles 1250 or 1260 is traveling 65 MPH.

At step 1030, the on-board module may analyze the signals to identify an error associated with the vehicle. For example, the on-board module may analyze the signals to identify any loose components of vehicles 1250 or 1260 (e.g., components not properly fastened to the vehicle, etc.). In some embodiments, step 1030 includes performing frequency analysis to determine whether a frequency signature associated with an error (e.g., a malfunctioning component/subcomponent, etc.) is present. Additionally or alternatively, step 1030 may include executing an AI model using the signals to identify any errors associated with the vehicle. For example, the on-board module may execute a CNN autoencoder model using vibration data from vehicles 1250 or 1260 to identify errors associated with vehicles 1250 or 1260. The errors may include brake squeal, excess wind noise (e.g., mirror whistle, etc.), excess road noise, HVAC health, an AC compressor fault, an out-of-balance rotor, drive bushing deterioration, chassis bushing deterioration, brake rotor thickness variation, excessive brake pad wear, wheel/tire imbalance, chassis damper leaks/failures, chassis misalignment, tire wear, gear/bearing failures (e.g., a wheel bearing failure, etc.), a half-shaft fracture, a CV joint fracture, and/or the like.

In certain embodiments, step 1030 includes performing analysis specific to the signals collected. For example, the on-board module may perform static tests (e.g., checking for horn, wipers, windows, and/or seatbelt chime functionality, etc.) on first signals collected while vehicles 1250 or 1260 is idling and may perform dynamic tests (e.g., checking for an out-of-balance rotor, etc.) on second signals collected while vehicles 1250 or 1260 is traveling 35 MPH. It should be understood that while step 1130 is described in reference to the on-board module, other processing systems such, as the vehicle data analysis system, may perform part or all of step 1130. For example, vehicles 1250 or 1260 may transmit the collected signals to the vehicle data analysis system and the vehicle data analysis system may apply an AI model trained using historical vehicle operation data to identify any errors associated with the vehicle.

At step 1040, the on-board module may determine whether the signals indicate an error associated with the vehicle is present. The on-board module may determine an error is present if the analysis in step 1130 identified an error (e.g., a loose component, an out-of-balance rotor, etc.). If the on-board module determines that an error is present (yes), then method 1100 may proceed with step 1150. At step 1150, the on-board module may perform a first action. For example, the on-board module may generate a notification for a technician that identifies the error. As another example, the on-board module may transmit a notification to an external system (e.g., a quality assurance computing system, etc.) identifying the error and including signals associated with the error (e.g., vibration data, etc.). In certain embodiments, step 1150 is associated with failing a vehicle audit (e.g., the vehicle requires servicing before it can enter the marketplace, etc.) If the on-board module determines that an error is not present (no), then method 1100 may proceed with step 1160. At step 1160, the on-board module may perform a second action. For example, the on-board module may update a database to reflect that the vehicle has passed a vehicle audit. In some embodiments, step 1160 includes saving the signals to a database (e.g., for root cause analysis should a problem arise with the vehicle, etc.).

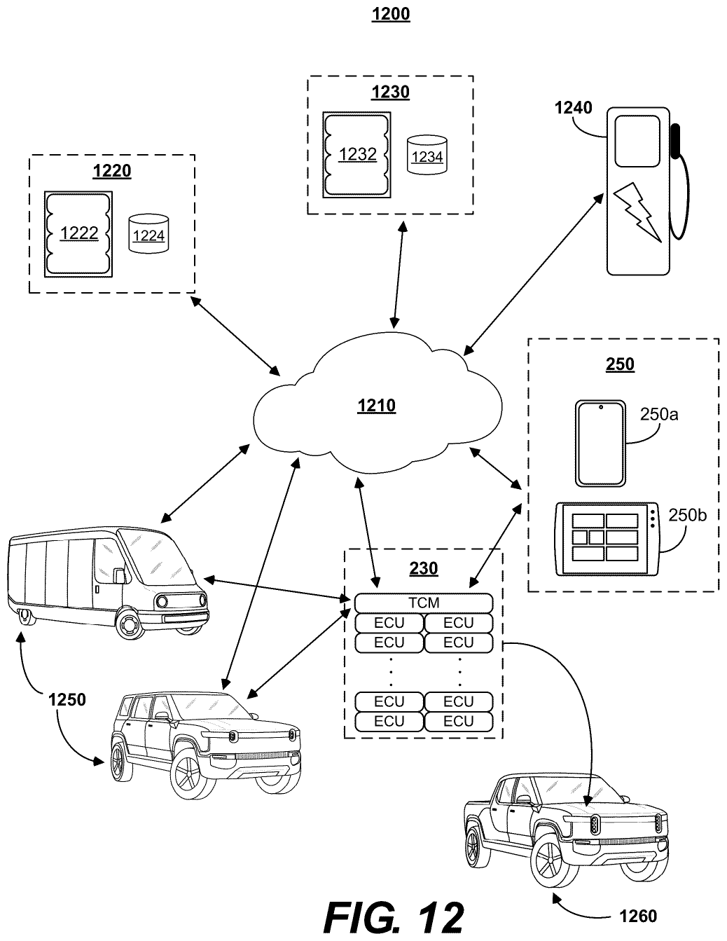

FIG. 12 illustrates an example networked environment 1200. Computer system 1200 may include a connected vehicles 1250 or 1260 with a control system 230 that is capable of transmitting data to/from a network 1210. Network 1210 may also be connected to one or more computing servers 1220 (e.g., including compute units 1222 and storage units 1224) associated with a vehicle manufacturer, a vehicle service provider, a vehicle fleet operator, or a vehicle-charging facility provider. Network 1210 may also be connected to one or more third-party computing servers 1230 (e.g., including compute units 1232 and storage units 1234) associated with, for example, a smart accessory manufacturer, a group event organizer, service provider, or a governmental organization.

Networked environment 1200 may include one or more landscape features 1240 (e.g., automated toll road sensors, smart road signs or road markers, automated toll gates, power dispensers at charging stations). Networked environment 1200 may also include other connected vehicles 1250 that may be capable of communicating with vehicles 1250 or 1260 through network 1210 and/or directly with vehicles 1250 or 1260 (e.g., by communicating with a TCM ECU of a control system 230 of vehicles 1250 or 1260 when connected vehicle 1250 is within range of a short-range communications network, such as Bluetooth). Networked environment 1200 may also include one or more computing devices 250 (e.g., smartphone 250a, a tablet computing device 250b, or a smart vehicle accessory) capable of communicating with network 1210 and/or directly with vehicles 1250 or 1260.

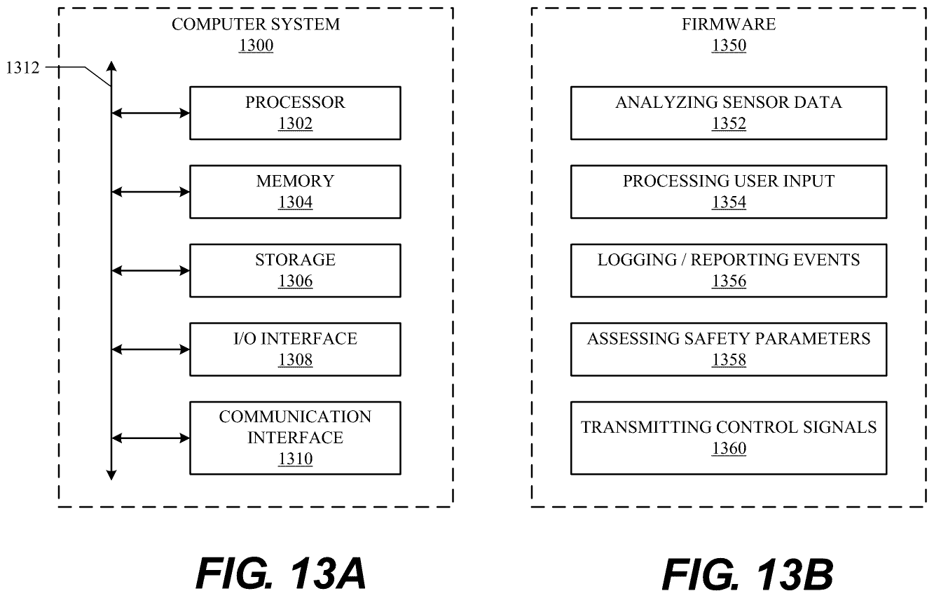

Networked environment 1200 may enable transmission of data and communications between any of the depicted elements. In some embodiments, such information may be communicated in only one direction (e.g., a smart road sign broadcasting information related to traffic control or delays due to construction); in other embodiments, information may include two-way communications (e.g., an automated toll gate that processes a request received from vehicles 1250 or 1260 to deduct a toll from a specified account and provides confirmation of the transaction). In particular embodiments, one or more elements of networked environment 1200 may include one or more computer systems, as described in further detail with respect to FIG. 13A. In particular embodiments, one or more elements of networked environment 1200 perform one or more steps of one or more methods described or illustrated herein. In particular embodiments, software running on one or more elements of networked environment 1200 may be controlled by a single entity to perform one or more steps of one or more methods described or illustrated herein or provide functionality described or illustrated herein.

FIG. 13A illustrates an example computer system 1300. Computer system 1300 may include a processor 1302, memory 1304, storage 1306, an input/output (I/O) interface 1308, a communication interface 1310, and a bus 1312. Although this disclosure describes one example computer system including specified components in a particular arrangement, this disclosure contemplates any suitable computer system with any suitable number of any suitable components in any suitable arrangement. As an example and not by way of limitation, computer system 1300 may be an electronic control unit (ECU), an embedded computer system, a system-on-chip, a single-board computer system, a desktop computer system, a laptop or notebook computer system, a mainframe, a mesh of computer systems, a mobile telephone, a personal digital assistant, a server computing system, a tablet computer system, or a combination of two or more of these. Where appropriate, computer system 1300 may include one or more computer systems 1300; be unitary or distributed, span multiple locations, machines, or data centers; or reside in a cloud, which may include one or more cloud components in one or more networks. Where appropriate, computer system(s) 1300 may perform, at different times or at different locations, in real time or in batch mode, one or more steps of one or more methods described or illustrated herein.

Processor 1302 (e.g., compute units 1222 and 1232) may include hardware for executing instructions, such as those making up a computer program. As an example and not by way of limitation, to execute instructions, processor 1302 may retrieve (or fetch) the instructions from an internal register, an internal cache, memory 1304, or storage 1306; decode and execute them; and then write one or more results to an internal register, an internal cache, memory 1304, or storage 1306 (e.g., storage units 1224 and 1234). Processor 1302 may include one or more internal caches for data, instructions, or addresses.

In particular embodiments, memory 1304 includes main memory for storing instructions for processor 1302 to execute or data for processor 1302 to operate on. In particular embodiments, one or more memory management units (MMUs) reside between processor 1302 and memory 1304 and facilitate accesses to memory 1304 requested by processor 1302. In particular embodiments, memory 1304 includes random access memory (RAM). This disclosure contemplates any suitable RAM.

In particular embodiments, storage 1306 includes mass storage for data or instructions. As an example and not by way of limitation, storage 1306 may include a removable disk drive, flash memory, an optical disc, a magneto-optical disc, magnetic tape, or a Universal Serial Bus (USB) drive or two or more of these. Storage 1306 may include removable or fixed media and may be internal or external to computer system 1300. Storage 1306 may include any suitable form of non-volatile, solid-state memory or read-only memory (ROM).

In particular embodiments, I/O interface 1308 includes hardware, software, or both, providing one or more interfaces for communication between computer system 1300 and one or more input and/or output (I/O) devices. Computer system 1300 may be communicably connected to one or more of these I/O devices, which may be incorporated into, plugged into, paired with, or otherwise communicably connected to vehicles 1250 or 1260 (e.g., through the TCM ECU). An input device may include any suitable device for converting volitional user input into digital signals that can be processed by computer system 1300, such as, by way of example and not limitation, a steering wheel, a touch screen, a microphone, a joystick, a scroll wheel, a button, a toggle, a switch, a dial, or a pedal. An input device may include one or more sensors for capturing different types of information, such as, by way of example and not limitation, sensors 210 described above. An output device may include devices designed to receive digital signals from computer system 1300 and convert them to an output format, such as, by way of example and not limitation, speakers, headphones, a display screen, a heads-up display, a lamp, a smart vehicle accessory, another suitable output device, or a combination thereof. This disclosure contemplates any suitable I/O devices and any suitable I/O interfaces 1308 for them. I/O interface 1308 may include one or more I/O interfaces 1308, where appropriate.

In particular embodiments, communication interface 1310 includes hardware, software, or both providing one or more interfaces for data communication between computer system 1300 and one or more other computer systems 1300 or one or more networks. Communication interface 1310 may include one or more interfaces to a controller area network (CAN) or to a local interconnect network (LIN). Communication interface 1310 may include one or more of a serial peripheral interface (SPI) or an isolated serial peripheral interface (isoSPI). In some embodiments, communication interface 1310 may include a network interface controller (NIC) or network adapter for communicating with an Ethernet or other wire-based network or a wireless NIC (WNIC) or wireless adapter for communicating with a wireless network, such as a WI-FI network or a cellular network.

In particular embodiments, bus 1312 includes hardware, software, or both coupling components of computer system 1300 to each other. Bus 1312 may include any suitable bus, as well as one or more buses 1312, where appropriate. Although this disclosure describes a particular bus, any suitable bus or interconnect is contemplated.

Herein, a computer-readable non-transitory storage medium or media may include one or more semiconductor-based or other integrated circuits (ICs) (such, as for example, field-programmable gate arrays or application-specific ICs), hard disk drives, hybrid hard drives, optical discs, optical disc drives, magneto-optical discs, magneto-optical drives, solid-state drives, RAM drives, any other suitable computer-readable non-transitory storage media, or any suitable combination. A computer-readable non-transitory storage medium may be volatile, non-volatile, or a combination of volatile and non-volatile, where appropriate.

FIG. 13B illustrates example firmware 1350 for a vehicle ECU 1300 as described with respect to control system 230. Firmware 1350 may include functions 1352 for analyzing sensor data based on signals received from sensors 210 or cameras 220 received through communication interface 1310. Firmware 1350 may include functions 1354 for processing user input (e.g., directly provided by a driver of or passenger in vehicles 1250 or 1260, or provided through a computing device 250) received through I/O interface 1308. Firmware 1350 may include functions 1356 for logging detected events (which may be stored in storage 1306 or uploaded to the cloud), as well as functions for reporting detected events (e.g., to a driver or passenger of the vehicle through an instrument display or interactive interface of the vehicle, or to a vehicle manufacturer, service provider, or third party through communication interface 1310). Firmware 1350 may include functions 1358 for assessing safety parameters (e.g., monitoring the temperature of a vehicle battery or the distance between vehicles 1250 or 1260 and nearby vehicles). Firmware 1350 may include functions 1360 for transmitting control signals to components of vehicles 1250 or 1260, including other vehicle ECUs 1300.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method for predicting fleet utilization or capacity for fulfilling a delivery demand, comprising, by one or more computing devices:
receiving vehicle data from one or more vehicles in a fleet of vehicles, wherein the vehicle data is related to delivery information associated with the one or more vehicles;
determining, based on the vehicle data, a health status of the one or more vehicles, wherein the health status comprises an indication of a health status of one or more components of the one or more vehicles;
generating a prediction of a fleet utilization or capacity for fulfilling a delivery demand based on the health status of the one or more vehicles; and
transmitting, based on the prediction of the fleet utilization or capacity, information to transfer a delivery load from the one or more vehicles to one or more other vehicles in the fleet to fulfill the delivery demand.

2. The method of claim 1, wherein the delivery information comprises historical data associated with one or more of delivery loads, delivery routes, driving conditions during deliveries, driving incidents, or delivery frequency with respect to the fleet of vehicles.

3. The method of claim 1, wherein the one or more components of the vehicle comprises one or more of a tire of the one or more vehicles, a high-voltage battery of the one or more vehicles, or a low-voltage battery of the one or more vehicles.

4. The method of claim 1, wherein the health status further comprises an indication of a mechanical wear of the one or more components, a condition of the one or more components, or a usage of the one or more components.

5. The method of claim 1, wherein generating the prediction of the fleet utilization or capacity comprises generating a prediction of a fleet utilization or capacity fulfilling a delivery demand in one or more specified geographical areas.

6. The method of claim 1, further comprising generating the prediction of the fleet utilization or capacity based on one or more of a historical downtime due to maintenance for the fleet of vehicles, a real-time or near real-time delivery load and routing demand for the fleet of vehicles, or a health status of the one or more other vehicles.

7. The method of claim 1, wherein transmitting information to transfer the delivery load further comprises transmitting information to the transfer the delivery load to another fleet of vehicles, accept an incoming transfer of the delivery load, request one or more temporary vehicles for which to transfer the delivery load, or request an order for additional vehicles to be included in the fleet of vehicles.

8. The method of claim 1, further comprising:
generating a prediction of a maintenance servicing for at least one of the one or more components of the one or more vehicles; and
updating the prediction of the fleet utilization or capacity based on the prediction of the maintenance servicing for the at least one of the one or more components.

9. The method of claim 8, further comprising transmitting information to schedule an action addressing the predicted maintenance servicing for the at least one of the one or more components.

10. The method of claim 9, further comprising:
subsequent to transmitting the information to transfer the delivery load, causing the action addressing the predicted maintenance servicing for the at least one of the one or more components to be executed.

11. The method of claim 10, further comprising:
receiving an indication that the action addressing the predicted maintenance servicing for the at least one of the one or more components has been executed; and
updating the prediction of the fleet utilization or capacity based at least in part on the received indication.

12. A fleet management system for predicting maintenance servicings for vehicle fleet planning and utilization, comprising:
one or more non-transitory computer-readable storage media including instructions; and
one or more processors coupled to the one or more storage media, the one or more processors configured to execute the instructions to:
receive vehicle data from one or more vehicles in a fleet of vehicles associated with a location, wherein the vehicle data is related to delivery information associated with the one or more vehicles;
determine, based on the vehicle data, a health status of the one or more vehicles, wherein the health status comprises an indication of a health status of one or more components of the one or more vehicles;
generate a prediction of a fleet utilization or capacity for fulfilling a delivery demand based on the health status of the one or more vehicles; and
transmit, based on the prediction of the fleet utilization or capacity, information to transfer a delivery load from the one or more vehicles to one or more other vehicles in the fleet to fulfill the delivery demand.

13. The fleet management system of claim 12, wherein the delivery information comprises historical data associated with one or more of delivery loads, delivery routes, driving conditions during deliveries, driving incidents, or delivery frequency with respect to the fleet of vehicles.

14. The fleet management system of claim 12, wherein the one or more components of the vehicle comprises one or more of a tire of the one or more vehicles, a high-voltage battery of the one or more vehicles, or a low-voltage battery of the one or more vehicles.

15. The fleet management system of claim 12, wherein the instructions to generate the prediction of the fleet utilization or capacity further comprise instructions to generate a prediction of a fleet utilization or capacity fulfilling a delivery demand in one or more specified geographical areas.

16. The fleet management system of claim 12, wherein the instructions further comprise instructions to generate the prediction of the fleet utilization or capacity based on one or more of a historical downtime due to maintenance for the fleet of vehicles, a real-time or near real-time delivery load and routing demand for the fleet of vehicles, or a health status of the one or more other vehicles.

17. The fleet management system of claim 12, wherein the instructions to transmit information to transfer the delivery load further comprise instructions to transmit information to the transfer the delivery load to another fleet of vehicles, accept an incoming transfer of the delivery load, request one or more temporary vehicles for which to transfer the delivery load, or request an order for additional vehicles to be included in the fleet of vehicles.

18. A non-transitory computer-readable medium comprising instructions that, when executed by one or more processors of one or more computing devices, cause the one or more processors to:
receive vehicle data from one or more vehicles in a fleet of vehicles associated with a location, wherein the vehicle data is related to delivery information associated with the one or more vehicles;
determine, based on the vehicle data, a health status of the one or more vehicles, wherein the health status comprises an indication of a health status of one or more components of the one or more vehicles;
generate a prediction of a fleet utilization or capacity for fulfilling a delivery demand based on the health status of the one or more vehicles; and
transmit, based on the prediction of the fleet utilization or capacity, information to transfer a delivery load from the one or more vehicles to one or more other vehicles in the fleet to fulfill the delivery demand.

19. The non-transitory computer-readable medium of claim 18, wherein the delivery information comprises historical data associated with one or more of delivery loads, delivery routes, driving conditions during deliveries, driving incidents, or delivery frequency with respect to the fleet of vehicles.

20. The non-transitory computer-readable medium of claim 18, wherein the one or more components of the vehicle comprises one or more of a tire of the one or more vehicles, a high-voltage battery of the one or more vehicles, or a low-voltage battery of the one or more vehicles.
